(19) United States
(12) Patent Application Publication
(10) Pub. No.: US 2024/0048524 A1
(43) Pub. Date: Feb. 8, 2024

(54) DISTANCE-BASED SELECTION

(71) Applicant: Telefonaktiebolaget LM Ericsson (publ), Stockholm (SE)

(72) Inventors: Attila MIHÁLY, Dunakeszi (HU); Åke ARVIDSSON, Åhus (SE)

(21) Appl. No.: 18/266,116

(22) PCT Filed: Jan. 20, 2022
(86) PCT No.: PCT/IB2022/050487

§ 371 Date: Jun. 8, 2023

Related U.S. Application Data
(60) Provisional application No. 63/139,902, filed on Jan. 21, 2021.

(51) Int. Cl. H04L 61/4511; H04L 61/4541; H04W 8/00

(52) U.S. Cl. CPC H04L 61/4511; H04L 61/4541; H04W 8/005

(57) ABSTRACT

Distance-based peer selection in which a peer discovery unit receives a target peer discovery request related to selecting a target peer for a source, obtains location information indicating a location of the source peer, selects candidate target peers, and determines distance information including routing distances from locations of the candidate target peers to the location of the source peer. A peer selection unit receives identifications of the candidate target peers and the distance information and uses the distance information to selection a target peer among the received candidate target peers.

### TECHNICAL FIELD

Disclosed are embodiments related to functionality to support distance-based section using domain name system (DNS) in 5G networks.

### BACKGROUND

1.1 Domain Name System (DNS)

The Domain Name System (DNS) is a hierarchical and decentralized naming system for computers, services, and other resources connected to the Internet or a private network. It associates various information with domain names assigned to each of the participating entities. Most prominently, it translates more readily memorized domain names to the numerical IP addresses needed for locating and identifying computer services and devices with the underlying network protocols.

The Domain Name System (DNS) has been defined by the Internet Engineering Task Force (IETF) and specifies the technical functionality of the database service that is at its core. It defines the DNS protocol, a detailed specification of the data structures and data communication exchanges used in the DNS, as part of the Internet Protocol Suite.

The Internet maintains two principal namespaces: (i) the domain name hierarchy (see 3rd Generation Partnership Project (3GPP) Technical Specification (TS) 23.501 v.16.5.0 System Architecture for the 5G System (5GS); Stage 2, Release 16) and (ii) the Internet Protocol (IP) address spaces (see 3GPP TS 23.502 v.16.5.0, Procedures for the 5G System (5GS); Stage 2, Release 16). The DNS maintains the domain name hierarchy and provides translation services between it and the address spaces. Internet name servers and a communication protocol implement the Domain Name System (see 3GPP TR 23.748, Study on enhancement of support for Edge Computing in the 5G Core network (5GC), v1.2.0, 2020.11, Release 17). A DNS name server is a server that stores the DNS records for a domain. A DNS name server responds with answers to queries against its database.

This application refers to stub resolvers, authoritative name servers, recursive resolvers, and intermediate resolvers. A stub resolver is a simple DNS protocol implementation on the client side as described in IETF Request for Comment (RFC) 1034, Section 5.3.1. A stub resolver sends DNS queries to a recursive resolver server.

An authoritative name server is a name server that has authority over one or more DNS zones. These are normally not contacted by a stub resolver or end user clients directly but by recursive resolvers. Authoritative name servers are described in IETF RFC 1035, Section 6.

A recursive resolver is a name server that is responsible for resolving domain names for clients by following the domain's delegation chain. Recursive resolvers frequently use caches to be able to respond to client queries quickly. Recursive resolvers are described in IETF RFC 1035, Section 7.

A forwarding resolver is a name server that passes that responsibility to another recursive resolver. A forwarding resolver is called a “Forwarder” in IETF RFC 2308, Section 1.

An intermediate name server is any name server in between the stub resolver and the authoritative name server, such as a recursive resolver or a forwarding resolver.

DNS is the most commonly used mechanism for application clients to discover IP addresses of applications on the Internet. The DNS allows users to handle application host names and have them translated into the IP address of the application server.

DNS today can return different responses based on the perceived topological location of the user. These servers use the IP address of the incoming query to identify that location. Because most queries come from intermediate recursive resolvers, the source address is that of the recursive resolver rather than of the query originator. Traditionally, and probably still in the majority of instances, recursive resolvers are reasonably close in the topological sense to the query originator. For these resolvers, using their own IP address is sufficient for authoritative name servers that tailor responses based upon location of the querier.

1.1.1 DNS Based Discovery and Selection in Universal Mobile Telecommunications Service (UMTS)

The European Telecommunications Standards Institute (ETSI) has devised procedures for node selection for Universal Mobile Telecommunications service (UMTS) and 4G networks (see “Domain Name System Procedures; Stage 3,” ETSI TS 129 303 V15.3.0, 09-2018) based on various IETF standards like RFC 2782 and RFC 3958, in which IP addresses are obtained through a series of Domain Name System requests. The procedures include support for locations, capacities, and, optionally through additional interfaces, loads.

The means devised by 3GPP TS 23.501 v.16.5.0 to support topological proximity is domain name string matching. For example, quoting 3GPP TS 23.501 v.16.5.0, pgw1.cluster1.net27.example.net is topologically closer to gw4.cluster1.net27.example.net (as they both are connected to “cluster1”) than to pgw1.cluster2.net27.example.net (with which it only has connection to “net27” in common).

1.1.2 RFC 7871 “Client Subnet in DNS Queries”

To address the case of recursive resolvers that are not topologically close to the query originator, IETF has defined RFC 7871.

This document defines an EDNS(0) (that is, an extension to DNS according to RFC6891) option to convey network information that is relevant to DNS messages. It can carry sufficient network information about the originator for the authoritative name server to tailor responses. It also provides for the authoritative name server to indicate the scope of network addresses for which the tailored answer is intended.

IETF RFC 7871 defines format and protocol handling of the EDNS client subnet (ECS) EDNS(0) option. That is meant to be sent in queries sent by intermediate name servers in a way that is transparent to query originators like stub resolvers, and to end users. An authoritative name server could use ECS as a hint to the end user's network location and provide a better answer. The authoritative name server's response would also contain an ECS option, clearly indicating that the server made use of this information, and that the answer is tied to the client's network. The ECS option in the response is intended to guide the caching of the answer provided.

The option includes the client address information in DNS messages. The option is structured as shown in FIG. 1. Defined in IETF RFC 6891, OPTION-CODE (2 octets) for ECS is 8 (0×00 0×08). Defined in IETF RFC 6891, OPTION-LENGTH (2 octets) contains the length of the payload (everything after OPTION-LENGTH) in octets. Defined in IETF RFC 7871, FAMILY (2 octets) indicates the family of the address contained in the option, using address family codes as assigned by the Internet Assigned Numbers Authority (IANA) in Address Family Numbers [Address_Family_Numbers].

The format of the address part depends on the value of FAMILY. IETF RFC 7871 only defines the format for FAMILY 1 (IPv4) and FAMILY 2 (IPv6), which are as follows:
SOURCE PREFIX-LENGTH, an unsigned octet representing the leftmost number of significant bits of ADDRESS to be used for the lookup. In responses, it mirrors the same value as in the queries.
SCOPE PREFIX-LENGTH, an unsigned octet representing the leftmost number of significant bits of ADDRESS that the response covers. In queries, it MUST be set to 0.

ADDRESS (variable number of octets) contains either an Internet Protocol (IP) version 4 (v4) or an IP version 6 (v6) address, depending on FAMILY, which MUST be truncated to the number of bits indicated by the SOURCE PREFIX-LENGTH field, padding with 0 bits to the end of the last octet needed.

1.2 5G Networks

The next generation (5G) networks architecture is defined in the new 3GPP Rel16. FIG. 2 depicts the 5G reference architecture as defined by 3GPP TS 23.501 v.16.5.0. The 5G Core (5GC) control plane is defined as a service-based architecture (SBA), where different services are grouped in network functions (NFs) that communicate via service-based interfaces. In some aspects, one or more of the NFs may have a cloud implementation.

The session management function (SMF) is the NF that is responsible for session establishment, modification, and release, including selection and control of the user plane function (UPF) entities, maintaining the topology of the involved packet data unit (PDU) session anchor (PSA) UPFs, establishing and releasing tunnels between Access Network (AN) (e.g., Radio Access Network (RAN)) and UPF and between UPFs. It also configures traffic forwarding at the UPF. SMF interacts with the UPF over the N4 reference point using Packet Forwarding Control Protocol (PFCP) procedures.

The User Plane Function (UPF) is the NF that handles the user data traffic. Among others, the UPF provides the external PDU Session point of interconnect to Data Network (DN) and performs packet routing and forwarding (e.g., support of Uplink classifier (UL CL) to route traffic flows to an instance of a data network and support of branching point for multi-homed PDU sessions).

The application function (AF) may send requests to influence SMF routing decisions for traffic of a PDU session. The AF requests may influence UPF (re)selection and allow routing user traffic to a local access in a DN (identified by a data network access identifier (DNAI)). The AF may communicate directly with the policy control function (PCF) in the SBA domain or indirectly through the network exposure function (NEF) (i.e., having an application programming interface (API) to the NEF that conveys the AF communication to the PCF).

The network repository function (NRF) provides support to register and discover NFs and NF services.

Many aspects of the 5G system imply selecting some NFs optimally for communication, and which NF is optimal could depend on the location of the given NF. Some examples are given below.

1.2.1 NF Discovery and Selection in 5G Networks

Inter-NF communication in the SBA domain starts with discovery of the communicating peer (if peer is not known). This discovery involves the NRF as shown in FIG. As shown in FIG. 3, the NF service consumer intends to discover services available in the network based on service name and target NF type. Therefore, the NF service consumer issues a discovery request to the NRF with a list of parameters about the required NF/service characteristics. The NRF responds with a list of NF profiles for the NFs that comply with the list of attributes sent in the request.

The NF profile in NRF response is a list of NF attributes (see clause 6.2.6.2. in 3GPP TS 23.501 v.16.5.0) that also includes the fully qualified domain name (FQDN) or IP address of NF and an operator-specific ‘location’ attribute. Examples of the operator-specific ‘location’ attribute can be geographical location and/or data centre. The NF service consumer could use this information to select an NF based on proximity.

1.2.2 Server Selection for Edge Computing (EC)

Some edge computing (EC) scenarios may require special selection of other NFs. UPF selection for EC is described in the next section (section 1.2.3). Connectivity to specific DN/DNAIs might require (re-)selection of the SMF by the access and mobility management function (AMF), and thus the AMF should perform this selection (using, e.g., NRF) based on DNAI (i.e., DNAI should be sent in the discovery request to the NRF, and NRF should filter the responses based on this DNAI).

When selecting an Edge Application Server for the user equipment (UE) and the UPF (anchor) of the UE is close to the UE (called the Distributed Anchor connectivity model), the DNS mechanisms using geo-location estimation based on UE IP address may be used. If the UE is configured to use an Operator DNS server as resolver, then the operator's resolver could apply the ECS option to indicate the location of the UE to the application's DNS (see clause 6.10.2.2 in 3GPP TR 23.748 v1.2.0).

In the case of edge application server (EAS) discovery for the Centralized Anchor and Session Breakout connectivity scenarios, there is a need for selecting the local DNS resolver (LDNSR), which is a new function that allows coordination of the EAS Discovery using DNS and the 5GC connectivity (see clauses 6.12 and 6.22 in 3GPP TR 23.748 v1.2.0). The LDNSR is a stand-alone 5GC NF with SBA interfaces with SMF and user plane (UP) external interfaces with UPF (to exchange DNS traffic with the UE) and with external UP interfaces with DNS entities on the DN.

Basically, LDNSR operates in the following way. LDNSR receives an uplink (UL) DNS query from the UE, inserts an ECS option, which includes an IP address/prefix obtained from SMF, into the DNS query and forwards it to a DNS resolver. The ECS option is related with the UE location and possibly the requested FQDN. Accordingly, based on ECS, an EAS will be selected according to the candidate DNAI/Local PSA.

LDNSR is selected by the SMF during PDU session establishment. The SMF may select the LDNSR based on the data network name (DNN) and/or Single-Network Slice Selection Assistance Information (S-NSSAI) of the PDU Session and on the PSA selected for the PDU Session. This selection may use NRF discovery or may be based on SMF local configuration.

1.2.3 UPF Selection

The mechanisms for User Plane Function (UPF) selection and re-selection by the SMF are described in 3GPP TS 23.501 v.16.5.0, clause 6.3.3. The selection could be based on pre-provisioned information in the SMF, or on NRF-based discovery as described above. The SMF could use this information to select an UPF based on proximity to the UE.

A special scenario for UPF selection is related to edge computing. As stated in 3GPP TS 23.501 clause 5.13, edge computing enables operators and 3rd party services to be hosted close to the UE's access point of attachment, so as to achieve an efficient service delivery through the reduced end-to-end latency and load on the transport network. The 5G Core Network selects a UPF close to the UE and executes the traffic steering from the UPF to the local Data Network via an N6 interface.

A number of enablers have been defined that alone or in combination support Edge Computing (chapter 5.13. in 3GPP TS 23.501 v. 16.5.0). Among those are (i) user plane (re)selection in which the 5G Core Network (re)selects UPF to route the user traffic to the local data network as described in clause 6.3.3 in 3GPP TS 23.501 v. 16.5.0 and (ii) local routing and traffic steering in which the 5G Core Network selects the traffic to be routed to the applications in the local data network.

This might require selecting a UPF that is close to a specific local Data Network. Clause 6.3.3 in 3GPP TS 23.501 v. 16.5.0 lists a number of criteria based on which UPF may be selected. “Information regarding the User plane termination(s) corresponding to DNAI(s)” is the information related to the position of the entry to the local data network that may be used.

### SUMMARY

Although some location information may be available for the selection scenarios listed in the previous sections (e.g., in the “location” attributes of the network functions (NFs) in the Network Repository Function (NRF) discovery responses or fully qualified domain name (FQDN) encodings in the domain name system (DNS) responses), but how this information is specified and is used by the selecting NFs is not clarified in the standards for 5G. This could lead to a management burden to configuring a consistent method through the 5G network, and even to suboptimal selection in some cases because of the different selection logic implementation in the NFs from the different vendors. It would be beneficial if a common method based on a centralized logic could be used for distance-based selection.

Regarding the current DNS-based edge application server (EAS) selection in the edge computing (EC) scenarios as described in section [0033] above, there is insufficient information available in the selection process. On the application side, it is only an IP address or subnet (the latter describing the would-be anchor and is received as EDNS client subnet (ECS) information) available for EAS selection. With this approach, the distance from the UPF (the would-be anchor) to the UE is not considered in the EAS selection process. The only possibility is to select the closest EAS to this IP address/range, but the application cannot check if the selected EAS would fulfil the key performance indicator (KPI) criteria needed for the application. If multiple EAS-es are sent as response, only a relative closeness to the respective IP/range may be conveyed (e.g., by ordering of the EAS IP addresses based on relative distance to the received IP/range). Because the UE-anchor distances are not known by the application, it is not possible to pre-select among available EASs based on some specific latency target.

On the operator side there is only EAS IP address information received but no absolute distance(s) to the (would-be) data network access identifier (DNAI). This makes it impossible for the session management function (SMF) to infer which EAS could fulfil the application specific KPI that might be available from the service level agreements (SLA) (unless SMF has pre-configured information, but this may not always be the case). So, the SMF is also unable to make a precise estimate of which EAS(es) may fulfil the KPI criteria. The SMF can only assume that the closest EAS fulfills the criteria and send this response to the UE. This is unreliable. Also, in in case of potential EAS or site failures, there is no alternative EAS to choose by the UE.

Aspects of the invention may overcome one or more of the problems with the existing solution by using a method for distance-based peer selection in which the selecting logic prepares and sends a query to a location repository (LR). The query may encode the location information on the logical topology of the entity for which the peer is to be selected, and the response from the LR may encode routing distance information relative to the location information included in the DNS query. The selecting logic may then perform distance based peer selection based on the received routing distance information.

Aspects of the invention may provide the advantage of allowing 5GC NFs leverage on LR services to apply a simplified method to select topologically close peers for communication. Aspects of the invention may facilitate interworking between the different NFs that could be provided by different vendors in the same 5G network.

Aspects of the invention may provide for EC use cases the advantage enabling a quantitative distance estimate to select appropriate user plane functions (UPFs) to UEs, local DNS resolver (LDNSR) to UPF, and edge application server (EAS) to UE if needed. For the selection of EAS to UE, aspects of the invention may provide the advantage of enabling sending more than one candidate EAS that fulfil specific KPI criteria that enables the UE to handle failure and overload scenarios.

In some aspects, the new LR logic may be integrated into the current peer discovery systems like DNS or network repository function (NRF), which enables that the distance-based discovery does not necessitate additional signaling.

One aspect of the invention may provide a method performed by a peer discovery unit. The method may include receiving a target peer discovery query related to the selection of a target peer for a source peer. The method may include obtaining location information indicating a location of the source peer. The method may include selecting first and second candidate target peers. The method may include using the location information for the source peer to determine distance information. The distance information may include a first routing distance between a location of the first candidate target peer and the location of the source peer and a second routing distance between a location of the second candidate target peer and the location of the source peer. The method may include conveying a response identifying the first and second candidate target peers, and the response may include the distance information.

In some aspects, the location information indicating the location of the source peer may include coordinate information for the source peer, an identifier of the source peer (e.g., identifying the source peer, a function provided by the source peer, a network slice, a sub-network, and/or a name space), and/or reference point distance information (e.g., including, for each of one or more reference points, a distance from the source peer to the reference point). In some aspects, the target peer discovery query may include the location information for the source peer. In some aspects, the target peer discovery query may include an identification of a target peer. In some aspects, the identification of the target peer may include the location information for the source peer. In some aspects, the identification of the target peer may include a fully qualified domain name (FQDN) of the target peer. In some aspects, the FQDN may include the location information for the source peer.

In some aspects, the location information for the source peer may include an Internet Protocol (IP) address or address range. In some aspects, the target peer discovery query may be a domain name system (DNS) query. In some aspects, a DNS extension (EDNS) may include the location information for the source peer. In some aspects, the EDNS may be an EDNS client subnet (ECS) extension. In some aspects, a zero (Z) header of the DNS query may include the location information for the source peer. In some aspects, an attribute of the target peer discovery query may include the location information.

In some aspects, the first and second routing distances may be in units of length. In some aspects, the first and second routing distances may be in units of time.

In some aspects, using the location information for the source peer to determine the distance information may include using the location information for source peer to select entries in a table (e.g., to select a table and/or a row or column of a table) and reading the selected entries as the first and second routing distances (e.g., reading the first and second routing distances from the selected table and/or the selected row or column of the table). In some aspects, routing distances of the table may be measured routing distances. In some aspects, the measured routing distances may be obtained by measurement probes at the locations of the candidate target peers. In some aspects, the routing distances may be provided by an operation and management (O&M) program.

In some aspects, an extension to the response may include the distance information. In some aspects, a zero (Z) header of the response may include the distance information. In some aspects, the response may include identifications of the first and second candidate target peers. In some aspects, the identifications of the first and second candidate target peers may include the first and second routing distances, respectively. In some aspects, the identifications of the first and second candidate target peers may include fully qualified domain names (FQDNs) of the first and second candidate target peers, respectively. In some aspects, the FQDNs of the first and second candidate target peers may include the first and second routing distances, respectively.

In some aspects, the first and second routing distances may be site location coordinates.

In some aspects, the peer discovery unit may be a domain name system (DNS). In some aspects, the peer discovery unit may be a central domain name system (C-DNS) server. In some aspects, the source peer may be a user equipment (UE).

In some aspects, the first and second candidate target peers may be user plane functions (UPFs). In some aspects, the target peer discovery query may include an identification of a UPF. In some aspects, the identification of the UPF may include a data network name (DNN) and/or network slice.

In some aspects, the first and second candidate target peers may be edge application servers (EASs). In some aspects, the source peer may by a local packet data unit (PDU) session anchor (PSA). In some aspects, the target peer discovery query may have been conveyed by a mobile network operator (MNO) domain name system (DNS), the location information may be an Internet Protocol (IP) address of the source peer, the response may include IP addresses that identify the EASs, and the first and second routing distances may be between the EASs and the location of the source peer. In some aspects, the target peer discovery query may have been conveyed by a local domain name system resolver (LDNSR), the response may include IP addresses that identify the EASs, and the first and second routing distances may be between the EASs and the location of the source peer. In some aspects, the first and second routing distances may be included in fully qualified domain names (FQDNs).

In some aspects, the peer discovery unit may be a network repository function (NRF), the first and second candidate target peers may be network functions (NFs), and the first and second routing distances may be between the NFs and the location of the source peer. In some aspects, the source peer is an NF service consumer. In some aspects, the target peer discovery query is conveyed by the NF service consumer. In some aspects, the NFs and the NRF may be part of a 5G Core (5GC) control plane defined as part of a service-based architecture (SBA).

Another aspect of the invention may provide a peer discovery unit. The peer discovery unit may be adapted to receive a target peer discovery query related to the selection of a target peer for a source peer. The peer discovery unit may be adapted to obtain location information indicating a location of the source peer. The peer discovery unit may be adapted to select first and second candidate target peers. The peer discovery unit may be adapted to use the location information for the source peer to determine distance information. The distance information may include a first routing distance between a location of the first candidate target peer and the location of the source peer and a second routing distance between a location of the second candidate target peer and the location of the source peer. The peer discovery unit may be adapted to convey a response identifying the first and second candidate target peers, and the response may include the distance information.

Still another aspect of the invention may provide a method performed by a peer discovery unit. The method may include receiving a target peer discovery query related to the selection of a target peer for a source peer. The method may include obtaining location information indicating a location of the source peer. The method may include selecting first and second candidate target peers. The method may include determining location information for the first and second candidate target peers. The method may include conveying a response identifying the first and second candidate target peers, and the response may include the location information for the first and second candidate target peers.

In some aspects, the location information indicating the location of the source peer may include coordinate information for the source peer, an identifier of the source peer (e.g., identifying the source peer, a function provided by the source peer, a network slice, a sub-network, and/or a name space), and/or reference point distance information (e.g., including, for each of one or more reference points, a distance from the source peer to the reference point). In some aspects, the location information for the first and second candidate target peers may include coordinates for the first and second candidate target peers and/or routing distances between the first and second candidate target peers and one or more reference points.

Yet another aspect of the invention may provide a peer discovery unit. The peer discovery unit may be adapted to receive a target peer discovery query related to the selection of a target peer for a source peer. The peer discovery unit may be adapted to obtain location information indicating a location of the source peer. The peer discovery unit may be adapted to select first and second candidate target peers. The peer discovery unit may be adapted to determine location information for the first and second candidate target peers. The peer discovery unit may be adapted to convey a response identifying the first and second candidate target peers, and the response may include the location information for the first and second candidate target peers.

Another aspect of the invention may provide a method performed by a peer selection unit. The method may include conveying a target peer discovery query related to the selection of a target peer for a source peer. The method may include receiving a response identifying first and second candidate target peers. The response may include distance information. The distance information may include a first routing distance between a location of the first candidate target peer and a location of the source peer and a second routing distance between a location of the second candidate target peer and the location of the source peer. The method may include using the first and second routing distances to select one or more of the first and second candidate target peers.

In some aspects, the target peer discovery query may include location information for the source peer. In some aspects, the location information for the source peer may include coordinate information for the source peer, an identifier of the source peer (e.g., identifying the source peer, a function provided by the source peer, a network slice, a sub-network, and/or a name space), and/or reference point distance information (e.g., including, for each of one or more reference points, a distance from the source peer to the reference point). In some aspects, the target peer discovery query may include an identification of a target peer. In some aspects, the identification of the target peer may include the location information for the source peer. In some aspects, the identification of the target peer may include a fully qualified domain name (FQDN) of the target peer. In some aspects, the FQDN may include location information for the source peer. In some aspects, the location information for the source peer may include an Internet Protocol (IP) address or address range.

In some aspects, the target peer discovery query may be a domain name system (DNS) query. In some aspects, the method may further include conveying a DNS extension (EDNS) including location information for the source peer. In some aspects, the EDNS may be an EDNS client subnet (ECS) extension. In some aspects, a zero (Z) header of the DNS query may include location information for the source peer.

In some aspects, the first and second routing distances may be in units of length. In some aspects, the first and second routing distances may be in units of time.

In some aspects, the method may further include receiving a trigger to select a target peer. In some aspects, the trigger includes an identification of the target peer. In some aspects, the identification of the target peer may be a fully qualified domain name (FQDN). In some aspects, the method may further include obtaining location information for the source peer.

In some aspects, an extension to the response may include the distance information. In some aspects, a zero (Z) header of the response may include the distance information. In some aspects, the response may include identifications of the first and second candidate target peers. In some aspects, the identifications of the first and second candidate target peers may include the first and second routing distances, respectively. In some aspects, the identifications of the first and second candidate target peers may include fully qualified domain names (FQDNs) of the first and second candidate target peers, respectively. In some aspects, the FQDNs of the first and second candidate target peers may include the first and second routing distances, respectively.

In some aspects, the first and second routing distances are site location coordinates. In some aspects, the source peer may be a user equipment (UE). In some aspects, the first and second candidate target peers may be user plane functions (UPFs). In some aspects, the method may further include receiving a packet data unit (PDU) session establishment request. In some aspects, the method may further include receiving location information for the UE. In some aspects, the location information for the UE may include a tracking area identifier (TAI) and cell identification (ID). In some aspects, the location information for the UE may be received in a packet data unit (PDU) session establishment request. In some aspects, the location information for the UE may be included in the target peer discovery query. In some aspects, the target peer discovery query may include a fully qualified domain name (FQDN) of a UPF, and the FQDN of the UPF may include the location information for the position of the UE. In some aspects, the FQDN of the UPF may include a data network name (DNN) and/or network slice. In some aspects, using the first and second routing distances to select one of the first and second candidate target peers may include selecting a UPF of a cluster that is located closest to the UE.

In some aspects, the first and second candidate target peers may be edge application servers (EASs). In some aspects, the source peer may be a local packet data unit (PDU) session anchor (PSA). In some aspects, the target peer discovery query may include an Internet Protocol (IP) address of the source peer, the response may include IP addresses that identify the EASs, and the first and second routing distances may be between the EASs and the location of the source peer. In some aspects, the response may include Internet Protocol (IP) addresses that identify the EASs, and the first and second routing distances may be between the EASs and the location of the source peer. In some aspects, the first and second routing distances may be included in fully qualified domain names (FQDNs). In some aspects, using the first and second routing distances to select one or more of the first and second candidate target peers may include determining that one or more of the first and second candidate target peers meets distance criteria. In some aspects, using the first and second routing distances to select one or more of the first and second candidate target peers may include selecting a data network access identifier (DNAI) and a local packet data unit (PDU) session anchor (PSA) at a location identified by the DNAI. In some aspects, using the first and second routing distances to select one or more of the first and second candidate target peers may include determining that the selected local PSA and the selected one or more of the first and second candidate target peers correspond to the selected DNAI. In some aspects, the method may further include: using the first and second routing distances to decide to change a local packet data unit (PDU) session anchor (PSA) to a new local PSA; selecting a new local PSA; and initiating a change of local PSA to the selected new local PSA.

In some aspects, the method may further include conveying the selected one or more of the first and second candidate target peers to a local domain name system resolver (LDNSR). In some aspects, the peer selection unit may be a session management function (SMF). In some aspects, the method may further include deferring selection of a new local packet data unit (PDU) session anchor (PSA) if none of the first and second candidate target peers meets distance criteria.

In some aspects, the peer selection unit may be a network function (NF) service consumer, the first and second candidate target peers may be network functions (NFs), the first and second routing distances may be between the NFs and the location of the source peer, and using the first and second routing distances to select one or more of the first and second candidate target peers may include selecting a candidate target NF that is topologically close to the NF service consumer. In some aspects, the source peer may be the NF service consumer. In some aspects, the target peer discovery query may include location information for the NF service consumer. In some aspects, the NFs may be part of a 5G Core (5GC) control plane defined as part of a service-based architecture (SBA).

Still another aspect of the invention may provide a peer selection unit. The peer selection unit may be adapted to convey a target peer discovery query related to the selection of a target peer for a source peer. The peer selection unit may be adapted to receive a response identifying first and second candidate target peers. The response may include distance information, and the distance information may include a first routing distance between a location of the first candidate target peer and a location of the source peer and a second routing distance between a location of the second candidate target peer and the location of the source peer. The peer selection unit may be adapted to use the first and second routing distances to select one or more of the first and second candidate target peers.

Yet another aspect of the invention may provide a method performed by a peer selection unit. The method may include conveying a target peer discovery query related to the selection of a target peer for a source peer. The method may include receiving a response identifying first and second candidate target peers. The response may include location information for the first and second candidate target peers. The method may include using the location information for the first and second candidate target peers to determine a first routing distance between a location of the first candidate target peer and a location of the source peer and a second routing distance between a location of the second candidate target peer and the location of the source peer. The method may include using the first and second routing distances to select one or more of the first and second candidate target peers.

In some aspects, the location information indicating the location of the source peer may include coordinate information for the source peer, an identifier of the source peer (e.g., identifying the source peer, a function provided by the source peer, a network slice, a sub-network, and/or a name space), and/or reference point distance information (e.g., including, for each of one or more reference points, a distance from the source peer to the reference point). In some aspects, the location information for the first and second candidate target peers may include coordinates for the first and second candidate target peers and/or routing distances between the first and second candidate target peers and one or more reference points.

Still another aspect of the invention may provide a peer selection unit. The peer selection unit may be adapted to convey a target peer discovery query related to the selection of a target peer for a source peer. The peer selection unit may be adapted to receive a response identifying first and second candidate target peers. The response may include location information for the first and second candidate target peers. The peer selection unit may be adapted to use the location information for the first and second candidate target peers to determine a first routing distance between a location of the first candidate target peer and a location of the source peer and a second routing distance between a location of the second candidate target peer and the location of the source peer. The peer selection unit may be adapted to use the first and second routing distances to select one or more of the first and second candidate target peers.

Yet another aspect of the invention may provide a method performed by a local domain name server resolver (LDNSR). The method may include conveying a domain name server (DNS) query including a fully qualified domain name (FQDN) requested by a user equipment (UE). The DNS query may include location information indicating a location of the UE. The method may include receiving a DNS response identifying first and second candidate edge application servers (EASs). The DNS response may include distance information, and the distance information may include a first routing distance between a location of the first candidate EAS and the location of the UE and a second routing distance between a location of the second candidate EAS and the location of the UE. The method may include conveying identifications of the first and second candidate EASs and the distance information to a session management function (SMF) for the UE.

In some aspects, the location information indicating the location of the UE may include coordinate information for the UE, an identifier of the UE, and/or reference point distance information (e.g., including, for each of one or more reference points, a distance from the UE to the reference point). In some aspects, the location information indicating the location of the UE may include an Internet Protocol (IP) address or address range. In some aspects, the IP address of the location information may correspond to a data network access identifier (DNAI) and/or a local packet data unit (PDU) session anchor (PSA) selected by a session management function (SMF) for the location of the UE. In some aspects, the FQDN of the DNS query may include the location information. In some aspects, a DNS extension (EDNS) to the DNS request may include the location information. In some aspects, the EDNS may be an EDNS client subnet (ECS) extension. In some aspects, a zero (Z) header of the DNS query may include the location information.

In some aspects, the DNS response may include the distance information. In some aspects, an extension to the DNS response may include the distance information. In some aspects, a zero (Z) header of the response may include the distance information. In some aspects, the identifications of the first and second candidate EASs may include the first and second routing distances, respectively. In some aspects, the identifications of the first and second candidate EASs may include FQDNs of the first and second candidate EASs, respectively. In some aspects, the FQDNs of the first and second candidate EASs may include the first and second routing distances, respectively.

In some aspects, the method may further include receiving a DNS query from the UE, the received DNS query may include the FQDN requested by UE, and the method may include modifying the received DNS query to create the conveyed DNS query. In some aspects, modifying the received DNS query may include adding the location information indicating the location of the UE.

In some aspects, the method may further include: receiving a list of one or more selected EASs conveyed by the SMF and conveying a DNS response including identifications of the one or more selected EASs. In some aspects, the list of one or more selected EASs may include FQDNs of the one or more selected EASs. In some aspects, the identifications of the one or more selected EASs may include Internet Protocol (IP) addresses and/or FQDNs of the one or more selected EASs.

In some aspects, the method may further include buffering the conveyed DNS query for early DNS handling and conveying the buffered DNS query with a different DNS extension (EDNS) client subnet (ECS) option.

In some aspects, the method may further include conveying the FQDN requested by the UE to the SMF.

In some aspects, the method may further include receiving an identification of a candidate local packet data unit (PDU) session anchor (PSA), the method may further include conveying a second DNS query, the second DNS query may include location information corresponding to the location of the candidate local PDU, the method may further include receiving a second DNS response identifying candidate EASs, the DNS response may include second distance information, and the second distance information may include routing distances between locations of the candidate EASs and the location of the candidate local PSA, and the method may further include conveying identifications of the candidate EASs and the second distance information to the SMF.

Still another aspect of the invention may provide a local domain name server resolver (LDNSR). The LDNSR may be adapted to convey a domain name server (DNS) query including a fully qualified domain name (FQDN) requested by a user equipment (UE) (702, 802). The DNS query may include location information indicating a location of the UE. The LDNSR may be adapted to receive a DNS response identifying first and second candidate edge application servers (EASs). The DNS response may include distance information, and the distance information may include a first routing distance between a location of the first candidate EAS and the location of the UE and a second routing distance between a location of the second candidate EAS and the location of the UE. The LDNSR may be adapted to convey identifications of the first and second candidate EASs and the distance information to a session management function (SMF) for the UE.

Yet another aspect of the invention may provide a method performed by a local domain name server resolver (LDNSR). The method may include conveying a domain name server (DNS) query including a fully qualified domain name (FQDN) requested by a user equipment (UE). The DNS query may include location information indicating a location of the UE. The method may include receiving a DNS response identifying first and second candidate edge application servers (EASs). The DNS response may include location information for the first and second candidate EASs. The method may include conveying identifications of the first and second candidate EASs and the location information for the first and second candidate EASs to a session management function (SMF) for the UE.

In some aspects, the location information indicating the location of the UE may include coordinate information for the UE, an identifier of the UE, and/or reference point distance information (e.g., including, for each of one or more reference points, a distance from the UE to the reference point). In some aspects, the location information for the first and second candidate EASs may include coordinates for the first and second candidate EASs and/or routing distances between the first and second candidate EASs and one or more reference points.

Still another aspect of the invention may provide a local domain name server resolver (LDNSR). The LDNSR may be adapted to convey a domain name server (DNS) query including a fully qualified domain name (FQDN) requested by a user equipment (UE). The DNS query may include location information indicating a location of the UE. The LDNSR may be adapted to receive a DNS response identifying first and second candidate edge application servers (EASs). The DNS response may include location information for the first and second candidate EASs. The LDNSR may be adapted to convey identifications of the first and second candidate EASs and the location information for the first and second candidate EASs to a session management function (SMF) for the UE.

Yet another aspect of the invention may provide a computer program including instructions for adapting an apparatus to perform any of the methods set forth above. Still another aspect of the invention may provide a carrier containing the computer program, and the carrier may be one of an electronic signal, optical signal, radio signal, or compute readable storage medium.

Still another aspect of the invention may provide an apparatus including processing circuitry and a memory. The memory containing instructions executable by the processing circuitry, whereby the apparatus is operative to perform any of the methods set forth above. Yet another aspect of the invention may provide an apparatus adapted to any of the methods set forth above.

Still another aspect of the invention may provide any combination of the aspects set forth above.

### BRIEF DESCRIPTION OF THE DRAWINGS

The accompanying drawings, which are incorporated herein and form part of the specification, illustrate various embodiments.

FIG. 1 illustrates the structure of the EDNS client subnet (ECS) EDNS(0) option.

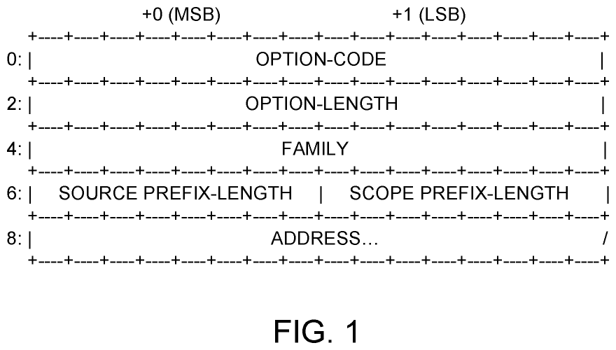

FIG. 2 illustrates the 5G network architecture.

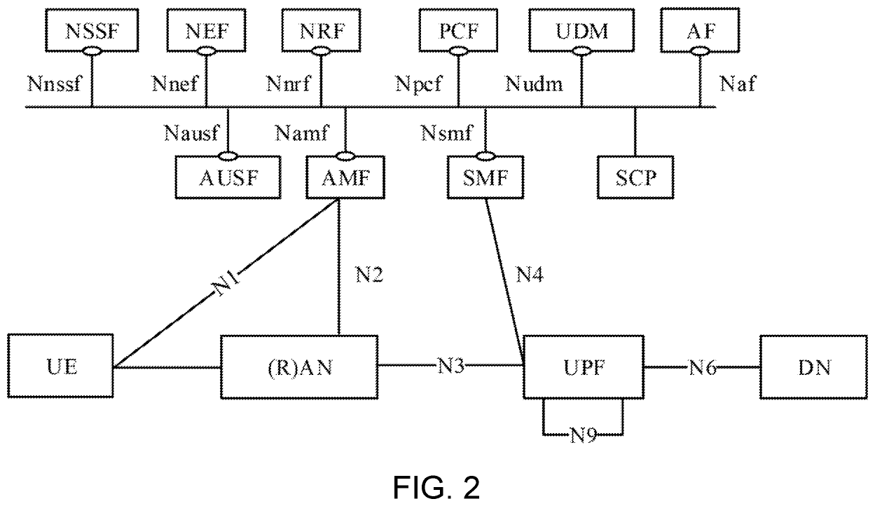

FIG. 3 illustrates the Network Function (NF)/NF service discovery in the same public and mobile network (PLMN) (taken from clause 4.17.3 in 3GPP TS 23.502 v.16.5.0).

FIG. 4 illustrates a system according to some aspects.

FIG. 5A illustrates the location repository (LR) functionality used for distance-based according to some aspects.

FIG. 5B illustrates an example of a network according to some aspects.

FIG. 6A illustrates a process for distance-based selection that may be performed by a peer selection unit and domain name system (DNS) in which the LR has been integrated according to some aspects.

FIG. 6B illustrates a process for user plane function (UPF) selection that may be performed by a session management function (SMF) according to some aspects.

FIG. 7 is a message flow diagram illustrating an edge application server (EAS) selection process using LDNSR according to some aspects.

FIG. 8 is a message flow diagram illustrating a process 800 for re-anchoring without change of SMF during EAS discovery using LDNSR according to some aspects.

FIG. 9A is a flowchart illustrating a process according to some aspects.

FIG. 9B is a flowchart illustrating a process according to some aspects.

FIG. 10A is a flowchart illustrating a process according to some aspects.

FIG. 10B is a flowchart illustrating a process according to some aspects.

FIG. 11A is a flowchart illustrating a process according to some aspects.

FIG. 11B is a flowchart illustrating a process according to some aspects.

FIG. 12 illustrates an apparatus according to some aspects.

### DETAILED DESCRIPTION

In this application, the term “node” can be a network node or a user equipment (UE). Examples of network nodes include, but are not limited to, a NodeB, a base station (BS), a multi-standard radio (MSR) radio node such as a MSR BS, an eNodeB, a gNodeB, a Master eNB (MeNB), a Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, remote radio unit (RRU), remote radio head (RRH), nodes in distributed antenna system (DAS), core network node (e.g. mobile switching center (MSC), mobile management entity (MME), etc.), operation and management (O&M), operation support systems (OSS), self-organizing network (SON), positioning node (e.g. evolved serving mobile location centre (E-SMLC)).

In this application, the term “user equipment” or “UE” is a non-limiting term that refers to any type of wireless device communicating with a network node and/or with another UE in a cellular or mobile communication system. Examples of UEs include, but are not limited to, a target device, a device to device (D2D) UE, a vehicular to vehicular (V2V), a machine type UE, an machine type communication (MTC) UE, a UE capable of machine to machine (M2M) communication, a PDA, a Tablet, a mobile terminal(s), a smart phone, laptop embedded equipment (LEE), laptop mounted equipment (LME), and USB dongles.

In this application, the terms “radio network node,” “network node,” and “NW node” is generic terminology that refers to any kind of network node including but not limited to a base station, a radio base station, a base transceiver station, a base station controller, a network controller, an evolved Node B (eNB), a Node B, a gNodeB (gNB), a relay node, an access point (AP), a radio access point, a Remote Radio Unit (RRU), a Remote Radio Head (RRH), a Central Unit (e.g. in a gNB), a Distributed Unit (e.g. in a gNB), a Baseband Unit, a Centralized Baseband, and a C-RAN.

In this application, the term “radio access technology” or “RAT” may refer to any RAT including, for example and without limitation, UTRA, E-UTRA, narrow band internet of things (NB-IoT), WiFi, Bluetooth, next generation RAT, New Radio (NR), 4G, and 5G. Any of the equipment denoted by the terms “node,” “network node,” or “radio network node” may be capable of supporting a single or multiple RATs.

Aspects are described in the context of New Radio (NR) (e.g., the remote UE and the relay UE are deployed in a same or different NR cell). However, the aspects are also applicable to other relay scenarios (e.g., where the link between remote UE and relay UE may be based on Long Term Evolution (LTE) sidelink or NR sidelink and/or the Uu connection between relay UE and base station may be LTE Uu or NR Uu). Some aspects are applicable to Layer 3 (L3) based relay scenarios.

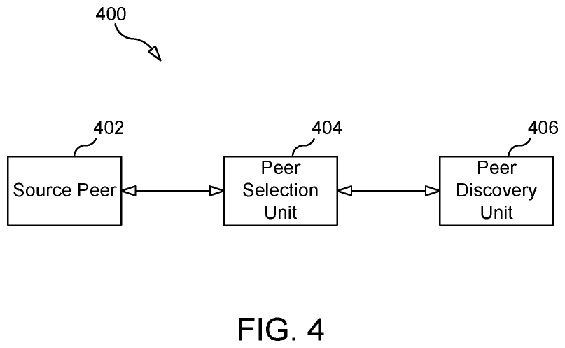

FIG. 4 illustrates a system 400 according to some aspects. In some aspects, as shown in FIG. 4, the system 400 may include a source peer 402, a peer selection unit 404, and/or a peer discovery unit 406. In some aspects, the source peer may be a user equipment (UE), a local packet data unit (PDU) session anchor (PSA), or a network function (NF) service consumer. In some aspects, the peer selection unit 404 may include a session management function (SMF), and the peer discovery unit 406 may include a domain name system (DNS). In some aspects, the DNS may include one or more resolvers and/or an authoritative DNS. In some aspects, the DNS may include a local DNS resolver (LDNSR) and a central DNS (C-DNS). In some aspects, the system 400 may employ a cloud infrastructure, cloud infrastructure discovery mechanisms may use DNS for service discovery, and DNS based solutions on the application level may facilitate integration to platform discovery mechanisms. In some alternative aspects, the peer selection unit 404 may include a network function (NF) service consumer, and the peer discovery unit 406 may include a network repository function (NRF). In some alternative aspects, the system 400 may not include a separate source peer 402 and peer selection unit 404, and, in these aspects, the source peer 402 may be the peer selection unit 404 and/or perform the functions of the peer selection unit 404 described below.

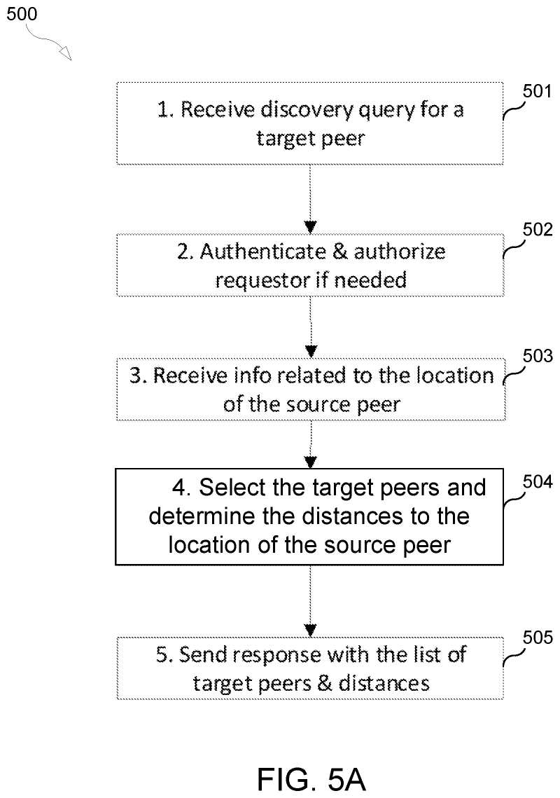

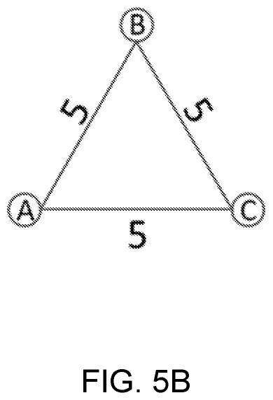

In some aspects, the new method for distance-based selection may involve location repository (LR) logic on the resolver side. FIG. 5A illustrates an example of an LR process 500 that may be performed by the peer discovery unit 406 according to some aspects.

In some aspects, the LR process 500 may include a step 501 in which the peer discovery unit 406 receives a query for a target peer to be selected for a source peer 402. In some aspects, the LR process 500 may include a step 502 in which the peer discovery unit 406 authenticates and authorizes the requestor if needed. In some aspects, the LR process 500 may include a step 503 in which the peer discovery unit 406 obtains information related to the location of the source peer 402. In some aspects, the information related to the location of the source peer 402 may be contained in the query. In some alternative aspects, the information related to the location of the source peer 402 may be available in the LR (e.g., in the peer discovery unit 406). In some aspects, the LR process 500 may include a step 504 in which the peer discovery unit 406 selects the target peers and determines the routing distance of each target peer to the location of the source peer 402 (if it was identified in step 503). See section [00121] below for more information about the distance estimation. In some aspects, the LR process 500 may include a step 505 in which the peer discovery unit 406 sends a response with the list of target peers and distances determined in step 504.

2.1 Determining the Distances to the Received Location

In some aspects, the location information obtained in step 503 may indicate a location of the source peer 402. In some aspects, the location information may include coordinate information for the source peer 402, an identifier of the source peer 402, and/or reference point distance information (e.g., including, for each of one or more reference points, a distance from the source peer 402 to the reference point). Multiple methods for distance estimation in the LR (e.g., in step 504 of the LR process 500) are possible.

For example, in some aspects in which the location information includes coordinate information for the source peer, the peer discovery unit 406 may calculate a routing distance between a location of a candidate target peer and the location of the source peer based on coordinate information for the candidate target peer and the coordinate information for the source peer. In some coordinate information aspects, the coordinate information for the source peer and the candidate target peers may be geographical coordinates, one-dimensional coordinates, or multi-dimensional coordinates (e.g., in Euclidian space). In some aspects using geographical coordinates, the accuracy of the determined distances may depend on the network topology.

With respect to one-dimensional coordinates, a complex network topology may be transformed to a straight line upon which all peers are placed such that the one-dimensional coordinates are indicative of locations of the network peers and allow distances between peers to be determined. In some aspects using one-dimensional coordinates, the determined distance may provide an upper bound on the true distance between the source peer and a candidate target peer. This is illustrated by the example network shown in FIG. 5B including network peers A, B, and C. Linearization of the network shown in FIG. 5B may be, for example, a line with peer A at one end, peer C at the other end, and peer B in the middle at a distance of 5 from both ends of the line. The one-dimensional coordinates for peers A, B, and C may thus be 0, 5, and 10, respectively, the distance between peers A and B may be determined correctly as 5 (i.e., 5−0=5), the distance between peers B and C may be determined correctly as 5 (i.e., 10−5=5), and the distance between peers A and C may be determined as 10 (i.e., 10−0=10), which would be an upper bound for the distance between A and C.

In some aspects using multi-dimensional coordinates, more accurate distances may be determined using multi-dimensional coordinates of the source and candidate target peers than using the one-dimensional coordinates obtained by linearization. However, transforming a network topology to multi-dimensional Euclidian space may require a large and possibly variable number of dimensions and may, therefore, be very complex in practice. To illustrate an aspect using multi-dimensional coordinates, the example network shown in FIG. 5B may be described by two-dimensional coordinates with peer A at (0, 0), peer B at (2.5, √18.25), which is approximately equal to (2.5, 4.33), and peer C at (0, 5).

In some aspects, multiple coordinate systems may be used for the same network. In some aspects, multiple coordinate systems may be used for the same network because, for example, different (e.g., virtual) slices may see different (e.g., virtual) topologies such that the determined distance between two peers may differ depending on which slice applies. For example, in some aspects, a physical network may support different slices (e.g., virtual subnetworks). In some aspects, each slice may include only a subset of the components of the underlying physical network. To illustrate an aspect using multiple coordinate systems using the network shown in FIG. 5B, one network slice may include only peers A and C but not the direct link between peers A and C. Instead, the network slice may include only the link between peers A and C via peer B, which may merely act as a passive router and thus be invisible to peers A and C). The linearization for this network slice may be a line with A placed at 0 and C placed at 10.

In some aspects, multiple coordinate systems may be used for the same network because, for example, the multiple coordinate systems may improve the accuracy of the determined distances. In some aspects, different linearization algorithms may each yield different coordinates for the peers and, therefore, different determined distances between peers. In some aspects using multiple coordinate systems, because the distances determined by the linearized network topology descriptions are upper bounds, the lowest distance determined by the different coordinate systems may be, by definition, the best approximation.

For example, a first linearization of the network shown in FIG. 5B may be the linearization described above having the line with peer A at one end, peer C at the other end, peer B in the middle at a distance of 5 from both ends of the line, and the one-dimensional coordinates for peers A, B, and C may thus be 0, 5, and 10, respectively. A second linearization of the network shown in FIG. 5B may switch the positions of peers B and C to yield a line with peer A at one end, peer B at the other end, and peer C in the middle at a distance of 5 from both ends of the line. The one-dimensional coordinates for peers A, B, and C in the second linearization may thus be 0, 10, and 5, respectively, the distance between peers A and B may be determined as 10 (i.e., 10−0=10), the distance between peers B and C may be determined correctly as 5 (i.e., 10−5=5), and the distance between peers A and C may be determined correctly as 5 (i.e., 5−0=5). In some aspects, the lowest of the distances between two peers determined using the first and second linearizations results in the correct distance for all pairs of peers. Accordingly, in some aspects, the determined distance between two peers may be the lowest of the distances between the two peers produced by multiple coordinate systems.

In some multiple coordinate system aspects, the location information may include at least first and second coordinates for the source peer under a first and second coordinate systems, respectively. In some multiple coordinate system aspects, each of the multiple coordinate systems may have a unique name, and the location information may include, for each of the multiple coordinate systems, the name of the coordinate system and the coordinates in that system. For example, continuing the example with different slices, in some aspects, certain peers may have to support more than one slice and may, for each slice request, respond with locations in a way that is unambiguous and understandable to all peers of that slice. For another example, continuing the example with different linearizations, in some aspects, distances may only be determined using coordinates referring to the same linearization. In some alternative aspects, distances may be determined by mixing coordinates from different linearizations, but the determined distance may no longer be guaranteed to be an upper bound.

In some aspects in which the location information includes an identifier of the source peer 402, the identifier may be a unique name (e.g., any subset of characters including numbers) of a peer. In some aspects, the identifier may be a descriptive name. In some aspects, an identifier may be used to look up a row or a column in a table from which distances may be read. In some aspects, an identifier of the source peer 402 may refer, for example, to a node, a site (e.g., a site with one or more nodes), or to an area (e.g., an area with one or more sites). In some aspects, an identifier of the source peer 402 may refer, for example and without limitation, to a cell or a tracking area.

One example using an identifier of the source is provided below. In this example, there is one encoding system for each site which itself is coded as zero and where all other sites are encoded by their distance to that site. In some aspects, distances may be noted in any unit (e.g., a distance unit such as kilometers or a time unit such as milliseconds). Actual server implementations in networks with S sites may then obtain such distances from, for example, tables with S rows and S columns where the origin coordinate is used to select a row (or a column) after which distances to service providers at other sites can be read from the corresponding column (or row) of that row (or column). In some aspects, all functions at one site may have the same location for each candidate target peer run on a machine in a site. In some aspects, separate machines may be desired (e.g., if one machine runs several virtualized functions, then the peer selection unit 404 may select the same machine for some or all of the functions the source peer 402 needs).

In some aspects, the LR in the peer discovery unit 406 may include pre-calculated tables for multiple sites. An example for three sites X, Y and Z is shown in the table below.

| | | X | Y | Z |
|---|---|---|---|---|
| Site name | Site number | 1 | 2 | 3 |
| X | 1 | 0 | 85 | 218 |
| Y | 2 | 85 | 0 | 75 |
| Z | 3 | 218 | 75 | 0 |

In some aspects, using the table above, a response to a request from site X is identified by its site number (encoding system), which is 1, and the distances to servers located at sites Y and Z would be reported as 85 and 218, respectively.

In some alternative aspects, the location of the source may be used to a select a table with just one row (or one column) from which distances to service providers at other sites can be read. In some aspects, the LR in the peer discovery unity 406 may include a pre-calculated table for each site. An example of a table for site X (site number 1) with distances to servers located at sites Y and Z is shown below. Here again, the distances to servers located at sites Y and Z would be reported as 85 and 218, respectively.

| Distance for Site Y (Site number 2) | Distance for Site Z (Site Number 3) |
|---|---|
| 85 | 218 |

In some aspects, the tables may be populated by O&M or by measurement probes at the different sites, measuring the distances (e.g., in terms of latency of forwarding table costs) to the peer sites. In some aspects, the latter provides robustness to accidental network failures. In some aspects, the different tables, rows, and/columns may be used for different network slices so that different distances may be provided for different slices of a network, and, for example, a table pointer may indicate a specific network slice.

In some aspects, the location information may include multiple identifiers for the source. For example, in some aspects in which descriptive names are used, the location information may include different names for different functions provided by the same physical source peer. For another example, in some aspects, if users of different slices prefer different names or if the identifiers are numbers referring to rows and/or columns of tables, the tables may be organized differently organized for different slices. In some aspects in which multiple identifiers are used, the identifiers may be separated in different name spaces, each name space may be assigned a unique name, and identifiers may be communicated in pairs including a globally unique name space and a locally unique identifier. Here, “globally unique” may refer to all peers involved in communicating location information and/or distance information, and “locally unique” may refer to all peers in the name space identified by the globally unique name.

In some aspects in which the location information includes reference point distance information, the reference point distance information may include, for each of one or more reference points, a distance from the source peer 402 to the reference point. In some aspects, a reference point may be a point in the network (e.g., a peer or a network gateway). In some aspects, a reference point may be a point in the network that is different than the point in the network at which the source peer is. In some aspects, a reference point may be a point in the network that is in the path between a source peer and a candidate target peer. In some reference point distance information aspects, the location of the source peer indicated by the location information may be the distance from the source peer 402 to the one or more reference points.

In some reference point distance information aspects, in step 504, the peer discovery unit 406 may determine a routing distance between a location of a candidate target peer and the location of the source peer using the reference point distance information. In some reference point distance information aspects, determining the routing distance using the reference point distance information may include determining the sum of (i) the distance between the source peer and a reference point (which may be included in the location information received in step 503) and (ii) a distance between the reference point and the candidate target peer. In some aspects, if the reference point is not exactly in the path between the source peer and the candidate target peer, the determined routing distance may be an approximation of (typically an upper bound to) of the actual routing distance between the location of the candidate target peer and the location of the source peer. In some aspects in which the location information received in step 503 includes distances from the source peer 402 to multiple reference points, determining the routing distance in step 504 may include determining, for each of the multiple reference points, a routing distance between the candidate target peer and the source peer via the reference point (e.g., as the sum of the received routing distance between the source peer and reference point and a routing distance between the reference point and the candidate target peer). In some aspects, the shortest of the determined routing distances between the location of the candidate target peer and the location of the source peer may be the best approximation of the actual routing distance between the location of the candidate target peer and the location of the source peer (and may be included in the response in step 505).

In some reference point distance information aspects, the location information received in step 503 may include, for each of the one or reference points, an identification of the reference point in addition to the distance from the source peer 402 to the reference point. However, this is not required, and, in some alternative aspects, a predefined order may be defined for the reference points, and the distance(s) between the source peer 402 and the one or more reference points may be provided in the location information as, for example, a set (e.g., vector) of distances (e.g., numbers). In some aspects, an empty (or special character) entry in the set may indicate that the distance from the source peer 402 to a particular reference point is unknown and/or not of interest.

In some aspects, the peer discovery unit 406 may use the routing distances determined for the candidate target peers in step 504 to restrict the candidate target peers identified in the response conveyed in step 505 (e.g., to those candidate target peers that appear closest to the source peer 402). In some alternative aspects, instead of conveying the routing distances between the locations of the candidate target peers and the location of the source peer, the peer discovery unit 406 may convey in step 505 location information for the candidate target peers (e.g., coordinates for the candidate target peers and/or routing distances between the candidate target peers and one or more reference points), and the peer selection unit 404 (or the source peer 402) may use the location information for the candidate target peers to determine routing distances between the locations of the candidate target peers and the location of the source peer. In these aspects, the peer selection unit 404 (or the source peer 402) may know or obtain supplementary knowledge about the distances between the source peer 402 and the one or more reference points for use in determining the routing distances between the locations of the candidate target peers and the location of the source peer. In some of the alternative aspects, only the peer selection unit 404 (or the source peer 402) and not the peer discovery unit 406 may determine the routing distances between the locations of the candidate target peers and the location of the source peer. However, aspects in which the peer discovery unit 406 determines the routing distances between the locations of the candidate target peers and the location of the source peer may enable more selective and therefore more concise responses in step 505 and/or offer simplifications with respect to maintaining algorithmic knowledge and computational power at the peer discovery unit 406 instead of maintaining it at the peers and/or the peer selecting units.

In some alternative aspects, the location information obtained in step 503 may include, for each of one or more reference points, an identification of the reference point but not include reference point distance information indicating a distance from the source peer 402 to the reference point. In some aspects, the query received in step 501 may contain a list of one or more reference points, and the response conveyed in step 505 may include triplets (peer identifier, reference point identifier, and distance between the identified peer and the identified reference point). In some aspects (e.g., aspects in which the query include only one reference point), the reference point identifier may be omitted from the response. In some of these aspects, the peer discovery unit 406 may convey in step 505 routing distances between the candidate target peers and the one or more reference points, and the peer selection unit 404 (or the source peer 402) may use the routing distances between the candidate target peers and the one or more reference points to determine routing distances between the locations of the candidate target peers and the location of the source peer (e.g., by summing (i) a distance between the source peer 402 and a reference point and (ii) the distance between the reference point and the candidate target peer). In these aspects, the peer selection unit 404 (or the source peer 402) may know or obtain supplementary knowledge about the distances between the source peer 402 and the one or more reference points for use in determining the routing distances between the locations of the candidate target peers and the location of the source peer. In some of these aspects, knowledge of the distances must be widely distributed. In some aspects, the knowledge may be set by configuration and/or regularly updated by data collection (e.g., active probing). In some of these aspects, not providing distances from the source peer 402 to one or more reference points may preserve the privacy of the source peer 402.

In some aspects, use of reference points may provide the advantage of simplified management due to the limited amount of information that needs to be known. In some aspects, peers may know their distances to all reference points. However, in some aspects, the total routing distance between the location of a candidate target peer and the location of a source peer may be calculated if the source peer and the candidate target peer both know their distance to at least one common reference point. In some aspects, use of reference points may provide the advantage of simplified management in cases where at least one peer is outside the network and where one or more network gateways are used as reference points. In some aspects, use of reference points may additionally or alternatively provide the advantage of a higher degree of privacy as distances to reference points may be less revealing than actual locations. In some aspects in which reference point information is used in addition to coordinate information for the candidate target peers, the reference point information may be used to supplement distance calculations from the coordinates and may improve accuracy (e.g., using the upper bound property).

In some aspects, coordinate information may be combined with reference point distance information (e.g., in location information for a source peer 402 and/or in location information for the candidate target peers). Coordinate information may be combined with reference point distance information, for example, if the distance metric is the same in the coordinate system and the reference point distance information. In some aspects, coordinate information and/or reference point distance information may be combined with identifiers for selection of a table or selection of a row or column of a table. Combining coordinate information and/or reference point distance information may be combined with identifiers may be useful, for example and without limitation, if it is preferable to have multiple candidate target peers at the same site and on the same instance of hardware (e.g., the same machine).

In some alternative aspects, the source peer 402 does not reveal information about its location but is aware of (a) its coordinates, (b) its own distance to one or more reference points, or (c) both. In some of these alternative aspects, the peer discovery unit 406 (e.g., DNS) cannot adapt its response to distances (e.g., the peer discovery unit 406 may answer a target peer discovery query blindly use the IP-address as a guide, but the IP-address may be neither certain nor reliable). In some aspects, the response may contain candidate target peers with distance information that the peer selection unit 404 (or the source peer 402) will be able to understand. That is, in some aspects, the peer discovery unit 406 may convey a response including (a) target peer coordinates, (b) distances from target peers to one or more reference points (with at least one of the one or more reference points being known by the source peer 402), or (c) both. In some aspects, the information included in the response may be defined or regulated (e.g., operator configuration, business contract, etc.) or, alternatively, all available information may be included in all responses. In some aspects, an advantage of the source peer 402 not revealing any information about its location may be increased privacy with respect to user location, and/or there may be no need for the peer discovery unit 406 to hold algorithmic knowledge (e.g., know how to compute distances from the given information) and computation power (e.g., to execute the aforementioned algorithm). However, in some aspects in which the source peer 402 does not reveal information about its location, responses may include every possible target peer to enable truly optimal choices with respect to distance, and the source peer 402 (or peer selection unit 404) may have the algorithmic knowledge and the computational power that the peer discovery unit 406 may not have.

In some aspects, an intermediate function (e.g., the peer selection unit 404) may change a target peer discovery query along the way to the peer discovery unit 406. For example, in some aspects, one or more intermediate functions may add or remove all or part of the location information for the source peer 402 to or from the target peer discovery query. For example, in some aspects, location information for the source peer 402 (e.g., source peer coordinates) may be added to an upstream query (e.g., by the source peer 402 or the peer selection unit 404) and any function (e.g., the peer discovery unit 406, peer selection unit 404, or source peer 402) having access to the location information for the candidate target peers (e.g., target peer coordinates) may convert the location information for the source peer 402 and the location information for the candidate target peers to distance information. For example, the peer discovery unit 406 may determine the distance information and include distance information in the response (with or without the location information for the candidate target peers). In some aspects, an intermediate function (e.g., the peer selection unit 404) may change a response from the peer discovery unit 406 identifying one or more candidate target peers along the way. For example, the peer discovery unit 406 may include in the response location information for the candidate target peers, and the peer selection unit 404 may use the location information for the candidate target peers and location information for the source peer 402 to determine the distance information.

In some aspects, source reference points may be included in an upstream query with distances from the source peer 402 to the reference points, and a function X (e.g., the peer selection unit 404) on the upstream path may remove these distances (and possibly even the reference point identifiers) on the upstream path. In some aspects, as the distances have been removed from the query, the downstream response may list references points and distances from candidate target peers to the reference points, and only the function X that removed the distances (or a function downstream of function X) may determine the complete distances from the candidate target peers to the source peer 402 via the reference points. In some aspects, the distances from the source peer 402 to the reference points (or other location information for the source peer 402) may be removed by the function X to keep the location of the source peer 402 hidden.

In some aspects, responses may be limited to what the peer selection unit 404 (or source peer 402) can use. For example, if the peer selection unit 404 (or source peer 402) only knows the distance from the source peer 402 to one reference point, the location information in the response may be limited to the distances from the candidate target peers to that one reference point. In some aspects, the reference points may follow from a slice identifier or some other identifier.

2.2 LR in DNS

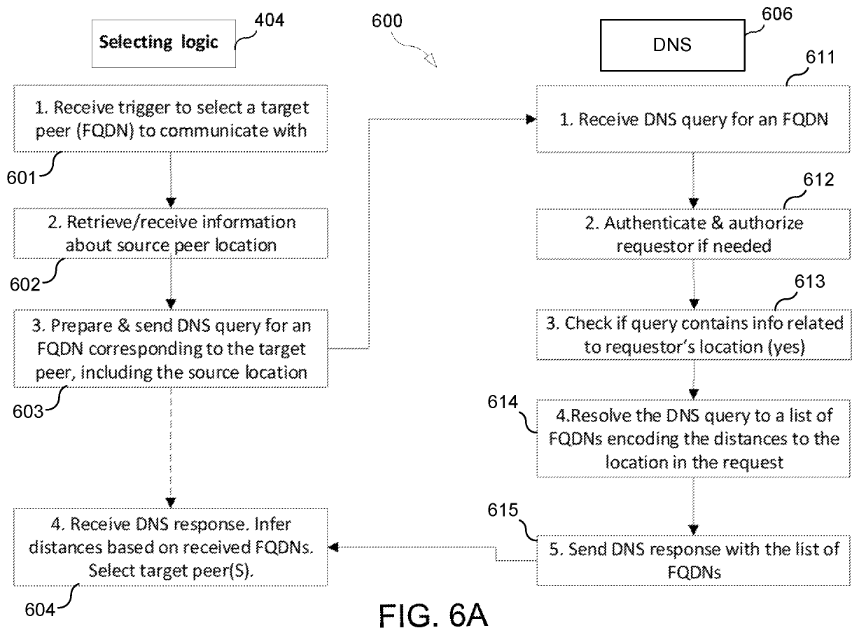

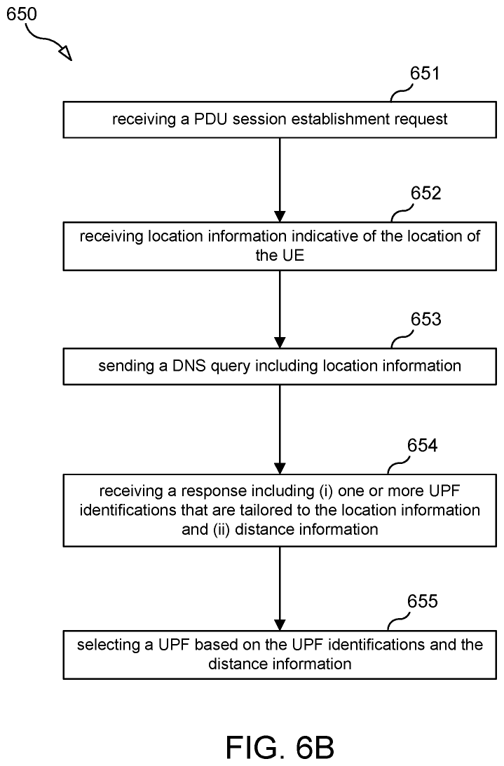

In some aspects, as shown in FIG. 6A, the peer discovery unit 406 may include a DNS 606. In some aspects, the LR logic may be integrated in or close by the DNS 606. FIG. 6A illustrates a process 600 for distance-based selection that may be performed by the peer selection unit 404 and DNS 606 according to some aspects. In some aspects, as shown in FIG. 6A, the process 600 for distance-based selection may include new logic both on the selector/requestor side and the resolver side.

In some aspects, as shown in FIG. 6A, the process 600 may include a step 601 in which the peer selection unit 404 receives a trigger to select a target peer to communicate with. In some aspects, the identity of the target peer may be in the form of a fully qualified domain name (FQDN). In some aspects, as shown in FIG. 6A, the process 600 may include a step 602 in which the peer selection unit 404 obtains (e.g., receives or retrieves) information about the location of the source peer (e.g., the peer for which the selecting entity should select a target peer for communication). In some aspects, the location information may include coordinate information for the source peer, an identifier of the source peer (e.g., identifying the source peer, a function provided by the source peer, a network slice, a sub-network, and/or a name space), and/or reference point distance information (e.g., including, for each of one or more reference points, a distance from the source peer to the reference point). In some aspects, the communication source may be co-located with the peer selection unit 404, and, in these aspects, the location information may be pre-configured by the O&M.

In some aspects, as shown in FIG. 6A, the process 600 may include a step 603 in which the peer selection unit 404 prepares and sends a query (e.g., a DNS query) for an identification (e.g., an FQDN) corresponding to the target peer. In some aspects, the query may include the location of the source node of the communication. See section 2.3 for more details about encoding location information into a DNS query, which may occur during step 603.

In some aspects, as shown in FIG. 6A, the process 600 may include a step 604 in which the peer selection unit 404 receives a DNS response. In some aspects, the DNS response may include identifications of candidate peers. In some aspects, the identifications may be FQDNs. In some aspects, the DNS response may include distance information indicating distances of the candidate target peers from the location of the source peer. In some aspects, the distance information may be included in the FQDNs. In some aspects, the distance information in the DNS response may include the distances between the locations of the candidate target peers and the location of the source peer. In some alternative aspects, the distance information in the DNS response may include location information for the candidate target peers (e.g., coordinates for the candidate target peers and/or routing distances between the candidate target peers and one or more reference points), and, in step 604, the peer selection unit 404 may infer the distances between the locations of the different candidate target peers and the location of the source peer based on the location information for the candidate target peers. In some aspects, in step 604, the peer selection unit 404 may select one or more target peers. In some aspects, the target peer selection may be based on the distances between the locations of the candidate target peers and the location of the source peer. In some aspects, the target peer selection may additionally or alternatively be based on other parameters and/or may additionally or alternatively involve additional DNS queries to resolve FQDN(s) of the selected peer(s).

In some aspects, as shown in FIG. 6A, the process 600 may include a step 611 in which the DNS 606 (e.g., LR logic incorporated in or close by the DNS 606) receives a DNS query for identification (e.g., an FQDN) of a target peer. In some aspects, as shown in FIG. 6A, the process 600 may include a step 612 in which the DNS 606 authenticates and authorizes the requestor if needed. In some aspects, as shown in FIG. 6A, the process 600 may include a step 613 in which the DNS 606 checks if the DNS query contains information related to requestor's location. In some aspects, the location information may include coordinate information for the source peer, an identifier of the source peer (e.g., identifying the source peer, a function provided by the source peer, a network slice, a sub-network, and/or a name space), and/or reference point distance information (e.g., including, for each of one or more reference points, a distance from the source peer to the reference point).

In some aspects, as shown in FIG. 6A, the process 600 may include a step 614 in which the DNS 606 resolves the DNS query to a list of one or more identifications (e.g., FQDNs) of target peers. In some aspects, the identifications may include routing distances from the target peers to the location of the request (e.g., if the location of the request was identified in step 613). In some aspects, the routing distances may be encoded in the identifications of the target peers. See section 2.3 for more details about encoding distance information in a DNS response. In some alternative aspects, the identifications may include location information for the candidate target peers (e.g., coordinates for the candidate target peers and/or routing distances between the candidate target peers and one or more reference points). In some aspects, as shown in FIG. 6A, the process 600 may include a step 614 in which the DNS 606 sends a DNS response with the list of one or more identifications of target peers determined in step 614.

2.3 Encoding Location and/or Distance Information in the DNS Query and Response

In some aspects, the DNS query sent from the peer selection unit 404 to the DNS 606 may include location information indicating the location of the source peer. In some aspects, the location information may include coordinate information for the source peer, an identifier of the source peer (e.g., identifying the source peer, a function provided by the source peer, a network slice, a sub-network, and/or a name space), and/or reference point distance information (e.g., including, for each of one or more reference points, a distance from the source peer to the reference point). In some aspects, the DNS response sent from the DNS 606 to the peer selection unit 404 may include distance information indicating distances from the location of the source to the locations of the candidate peers. In some alternative aspects, the DNS response may include location information for the candidate target peers (e.g., coordinates for the candidate target peers and/or routing distances between the candidate target peers and one or more reference points). In some aspects, the location information may be encoded in the DNS request, and the distance information (or location information for the candidate target peers) may be encoded in the DNS response.

In some aspects, the location information may be encoded in the DNS query using the existing EDNS client subnet (ECS) extension. The IP address range is also an indicator of the location (e.g., of a site the requestor tries to find the distances from). This option may only be used in the DNS query, while the DNS response should use one of the following alternatives below.

In some other alternative aspects, the location information may be encoded in the DNS query and/or the distance information (or location information for the candidate target peers) may be encoded in the DNS response using a new DNS extension to communicate location and/or distance information (or location information for the candidate target peers). This embodiment may require new standardization so that intermediate resolvers do not drop this extension.

In some further alternative aspects, the location information may be encoded in the DNS query and/or the distance information (or the location information for the candidate target peers) may be encoded in the DNS response by encoding the location information into the DNS query and/or by encoding distance information in the response. In some aspects, the location and/or distance information may be included in the Z (zero) header field in the DNS query and/or response, respectively. The Z header field is currently reserved for future use. In this embodiment, an internal DNS server (integrating the LR) would extract the source peer's location information from the Z header and/or would insert distance information (or location information for the candidate target peers) here in the Z header field of the DNS response.

In some other alternative aspects, the location information may be included in the FQDN of the DNS query, and/or the distance information (or location information for the candidate target peers) may be encoded in the FQDNs of the DNS response. This approach may be fully compatible with standard DNS. To illustrate this embodiment with the example network including the three sites X, Y and Z described above in section 2.1, we assume that pgw1.cluster1.net27.example.net is located at site Y, that pgw1.cluster2.net27.example.net is located at site Z, and that the request originates from site X. In this example, the peer selection unit 404 may request PGW<>1.example.net where PGW indicates the service and 1 indicates the location of the requester/source peer such that the responder (e.g., DNS 606) can calculate distances to the requester at site X and tailor its response by responding with pgw1.cluster1.net27.example.net<>85 and pgw1.cluster2.net27.example.net<>218. In this example, “<>” may be used as a delimiter, but, in some alternative aspects, one or more different delimiters may be used.

In some aspects, queries like PGW< >1 may be handled even if “<>” is not recognized as a limiter and 1 thus not recognized as a site identifier. In some aspects, this may be accomplished by interpreting “PGW<>1” as a service and register pgw1.cluster1.net27.example.net (with or without distance information) as the provider of this service (and other services PGW<>x for all sites x for which the instance pgw1.cluster1.net27.example.net is considered a relevant choice of PGW).

In some aspects, the particular choices of delimiter “<>” and placement just constitute an example and that locations and/or distances can be placed and identified in many ways. Another possibility is, for example, to use the “.” delimiter to place the site number or distance information (e.g., site_1.pgw.example.net and site_1<>85.pgwL.cluster1.net27.example.net). This approach could simplify the DNS configuration by using wildcards.

In the aspects that use the new DNS extension and/or supplement the FQDNs, service provider distances may be indicated as site location coordinates, which may simplify additions and reductions of (virtual) server instances in response to, for example, increasing or decreasing demand.

2.4 Example: UPF Selection at Session Setup

In some aspects, the distance-based selection may be applied in the user plane functions (UPF) selection. In this example, the source peer 402 may be a UE, the peer selection unit 404 may be a session management function (SMF), and the peer discovery unit 406 may be a DNS.

FIG. 6B illustrates a process 650 performed by the SMF when performing UPF selection according to some aspects. In some aspects, as shown in FIG. 6B, the SMF may perform a step 651 in which the SMF receives a PDU session establishment request. The PDU session establishment request may have been initiated by the UE and forwarded to SMF via access and mobility management function (AMF) in a Nsmf_PDUSession_CreateSMContext Request message. See clause 4.3.2.2.1 in 3GPP TS 23.502 v. 16.5.0.

In some aspects, the SMF may perform a step 652 in which the SMF receives location information indicative of the location of the UE. In some aspects, the location information may include coordinate information for the UE, an identifier of the UE (e.g., identifying the UE, a function provided by the UE, a network slice, a sub-network, and/or a name space), and/or reference point distance information (e.g., including, for each of one or more reference points, a distance from the UE to the reference point). In some aspects, the location information may be UE (RBS) location information. The SMF may need the UE (RBS) location information to select a UPF topologically close to the UE. The UE (RBS) location information may be conveyed in the Nsmf_PDUSession_CreateSMContext Request message received from the AMF in the form of tracking area identifier (TAI) and cell ID.

In some aspects, the SMF may perform a step 653 in which the SMF converts the received location information (TAI, CellID) to some location attribute if needed (e.g., based on local configuration of, for example, site number as outlined in section [00155] above). In some aspects, the step 653 may include the SMF sending a DNS query to a DNS server deploying an LR for the UPF. The DNS query may contain location information about the location of RBS using one of the methods described above. For example, the SMF may encode the location information in an FQDN of the UPF, and the FQDN in the query may look like site_1.upf.example.net. In some aspects, the FQDN of the UPF may additionally or alternatively contain other information related to the UPF selection (e.g., data network name (DNN), network slice or other information).

In some aspects, the SMF may perform a step 654 in which the SMF receives a response from the DNS server deploying a location repository (LR). In some aspects, the DNS response may include one or UPF identifications (e.g., FQDNs) that are tailored to the site identity sent in the query. In some aspects, the DNS response (e.g., the UPF identifications of the response) may contain topological distance information from the given site as described in section 2.3 above (e.g., upf1.cluster1.net27.example.net, upf2.cluster1.net27.example.net, and upf1.cluster2.net27.example.net). In some aspects, the distances (e.g., 75, 85 and 218) that are specific to the site identity sent in the query may be conveyed in new DNS extensions or added to the FQDNs. If the distance information is added to the FQDNs, the received resources records (RRs) may look like: (i) site_1<>85.upf1.cluster1.net27.example.net, type A, class INET, addr 1.2.3.4, (ii) site_1<>85.upf2.cluster1.net27.example.net, type A, class INET, addr 5.6.7.8, and/or (iii) site_1<>218.upf1.cluster2.net27.example.net, type A, class INET, addr 8.7.6.5. In some alternative aspects, the DNS response may include location information for the candidate UPFs (e.g., coordinates for the candidate UPFs and/or routing distances between the candidate UPFs and one or more reference points).

In some aspects, the SMF may perform a step 655 in which the SMF selects the UPF. In some aspects, the UPF selection may be based on the distance information or the location information for the candidate UPFs (e.g., encoded in the UPF FQDNs). In some aspects in which the response includes location information for the candidate UPFs, the SMF may use the location information the candidate UPFs to determine distances from the location of the UE to the locations of the candidate UPFs. If all three of the identified UPFs are selectable, the SMF may choose UPF1 or UPF2 at cluster 1 as an anchor for this PDU session (because UPF1 or UPF2 at cluster 1 is closer than UPF1 at cluster 2), and the choice between UPF1 and UPF2 at cluster 1 may be made at random or based on other attributes such as, for example, capacity and/or load included in the response or known in other ways.

2.5 Example: EAS selection

In some aspects, the distance-based selection may be applied for edge application server (EAS) selection in case of edge computing (EC) for a number of connectivity models.

In the case of distributed anchor connectivity model (see clause 6.10.2.2 in 3GPP TR 23.748 v1.2.0), the operator DNS may add an EDNS client subnet (ECS) corresponding to the user IP address, and the DNS response sent back to the mobile network operator (MNO) DNS may contain a list of EAS IP addresses and FQDNs including distance to the site identified in the prefix in the ECS (see section 2.3 above). Based on the distances, the EASs could be filtered by the MNO DNS based on distance criteria and then those fulfilling some pre-agreed upon requirements may be sent to the UE.

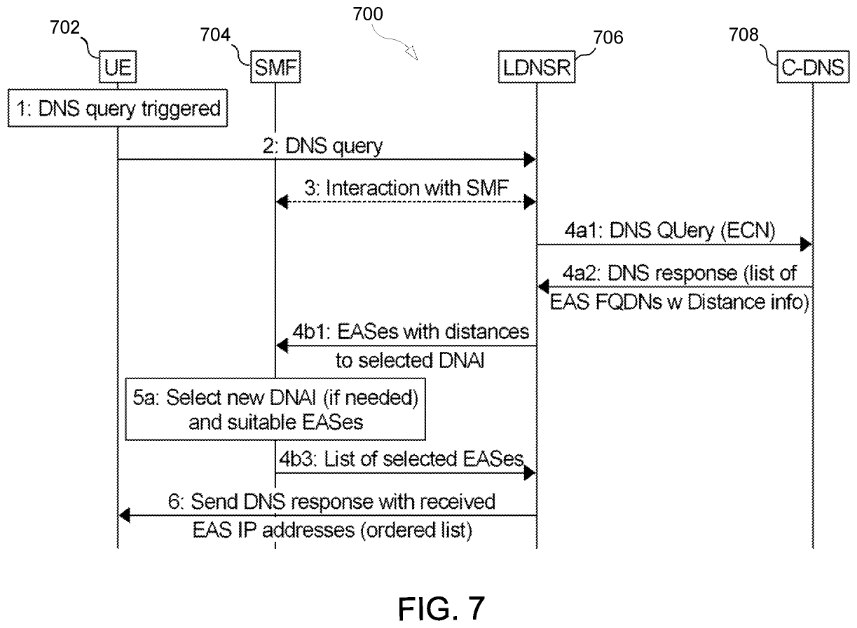

FIG. 7 is a message flow diagram illustrating a process 700 for dynamic EAS discovery and selection for the session break-out connectivity model according to some aspects (compare FIG. 7 with Figure 6.22.2-1, Option 1 in clause 6.22.2 in 3GPP TR 23.748 v1.2.0). In these aspects, the source peer 402 may be a UE 702, the peer selection unit 404 may be a session management function (SMF) 704, and the peer discovery unit 406 may include a local DNS resolver (LDNSR) 706 and a central DNS (C-DNS) 708.

In some aspects, as shown in FIG. 7, the process 700 may include a step 1 in which the UE 702 sends a DNS query including the requested FQDN. In some aspects, the process 700 may include a step 2 in which the DNS query reaches the LDNSR 706 through the central anchor. In some aspects, the process 700 may include a step 3 in which, the LDNSR 706 interacts with the SMF 704 and receives from the SMF 704 a configuration for the FQDN in the DNS query.

In some aspects, the step 3 may include the LDNSR 706 determining forwarding parameters based on the configuration for the FQDN in the DNS query received from the SMF 704. In some aspects, the forwarding parameters may include the IP address to add as ECS DNS option. This IP address may correspond to the DNAI/Local PSA selected by the SMF 704 for the UE location and a target domain. In some aspects, the LDSNR 706 may have these forwarding parameters as part of the instructions received from SMF 704 before or may fetch these forwarding parameters from the SMF 704 by providing the FQDN to the SMF 704 in step 3.

In some aspects, as shown in FIG. 7, the process 700 may include a step 4a1 in which the LDNSR 706 adds the IPv4 subnet or IPv4 address or IPv6 prefix provisioned by SMF 704 in step 3 as ECS option as specified in IETF RFC 7871 and sends it to central DNS (C-DNS) (e.g., Service DNS) server 708. In some aspects, the process 700 may include a step 4a2 in which the C-DNS 708 returns a DNS response. In some aspects, the DNS response may include one or more EAS FQDNs in priority order. In some aspects, each FQDN may include distance to the site (or location information for the candidate EASs) identified in the prefix in the ECS (e.g., as described in section [00155] above). In some aspects, these FQDNs with distance (or location) encodings may be sent as additional type A RRs (which is possible by standard DNS, see IETF RFC 1034 states (section 3.7.1.) including their corresponding EAS IP addresses as well).

In some aspects, as shown in FIG. 7, the process 700 may include a step 4b1 in which, after receiving the DNS response, the LDNSR 706 informs SMF 704 with IP address of EASs and received EAS FQDNs including the distance information (or location information for the candidate EASs) if certain criteria set by SMF 704 are matched (e.g., the IP address of EAS in DNS response is within the IP range(s) indicated by SMF 704, or the FQDN is matched).

In some aspects, as shown in FIG. 7, the process 700 may include a step 5a in which the SMF decides DNAI and performs uplink (UL) CL/Local PSA selection and set up. The DNAI and UL CL/Local PSA2 may be selected based on the information provided by LDNSR 706 to ensure the selected local PSA and EAS are corresponding to same DNAI and to ensure certain distance criteria to the UE 702 are met. In some aspects, the total distance may be estimated based on the UE-to-Local PSA (UPF) distance that may be available to the SMF 704 from the UPF selection, plus the distance information received from the C-DNS 708. A new, higher-level DNAI may be selected in the case of a hierarchical operator topology and if the EASs are reported to be further away than the distance to this DNAI, if this re-selection provides less cost or is needed for load balancing reasons (note that the DNAI re-selection will not impact the distance to the EAS in this case). In some aspects, the SMF 704 may also decide on a DNAI re-selection in the case of none of the answers matching the distance requirement. In this case, the SMF 704 may notify the LDNSR 706 to send an alternative query relative to another candidate location (i.e., new DNAI). That is, the procedure may be repeated from step 4a1 with another candidate location.

In some aspects, as shown in FIG. 7, the process 700 may include a step 4b3 in which the SMF 704 responds to LDNSR 706 with the list of EAS FQDNs selected in step 5a that fulfil the selection criteria including distance criterion. In some aspects, the process 700 may include a step 6 in which the LDNSR 706 sends a DNS response to UE 702. In some aspects, the DNS response may include including one or more EAS FQDNs or IP addresses (selected by the SMF) in preference order.

In some aspects, the process 700 may provide one or more of the following advantages. First, the process 700 may provide the possibility to have absolute path delay estimates in the SMF 704 (as opposed to the relative path delay estimate in the existing method). Second, the UE 702 may use the first (best suited) IP address to connect, but it has additional IP addresses to choose from if that does not work. This enhances resiliency against failures (e.g., if connectivity to a certain edge data network (DN) fails, the UE 702 may re-select an EAS at another DN that is still fulfilling the latency requirements). Third, the UE 702 may perform on the application layer KPI measurements to avoid the path or EAS overload.

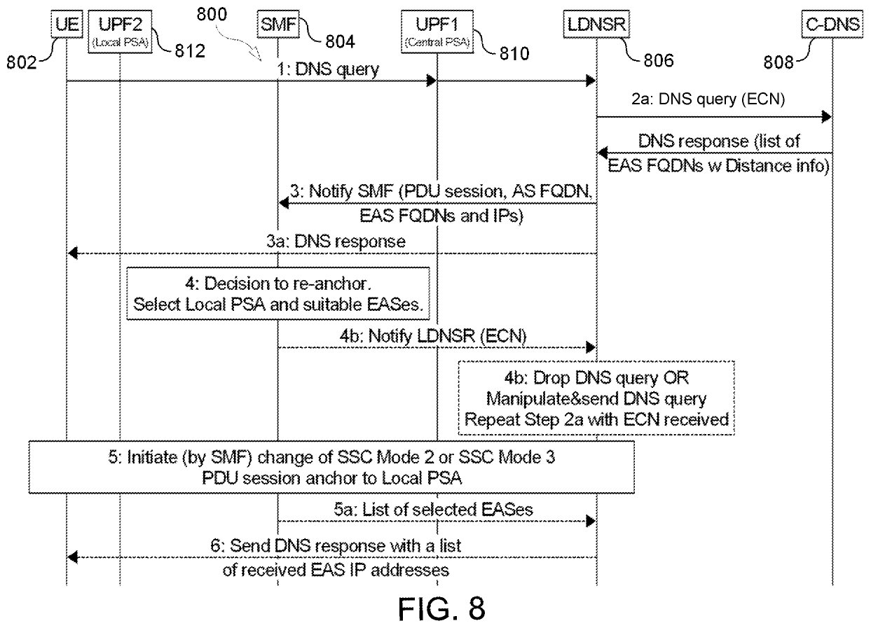

FIG. 8 is a message flow diagram illustrating a process 800 for re-anchoring use case for the centralized anchor connectivity model (see clause 6.12 in 3GPP TR 23.748 v1.2.0) according to some aspects (compare FIG. 8 with Figure 6.12.2-1, Option 1 in clause 6.12.2 in 3GPP TR 23.748 v1.2.0). In these aspects, the source peer 402 may be a UE 802, the peer selection unit 404 may be a session management function (SMF) 804, and the peer discovery unit 406 may include a local DNS resolver (LDNSR) 806 and a central DNS (C-DNS) 808.

In some aspects, as shown in FIG. 8, the process 800 may include a step 1 in which the application in the UE 802 does a DNS discovery request to discover the EAS. At least for edge computing (EC) application server (AS)-FQDNs, the DNS request may be handled via a central PSA 810 (UPF1) by the LDNSR 806. In some aspects, the LDNSR 806 may check whether the FQDN in the DNS Query may be an FQDN for which it needs to provide a specific handling. Such EC FQDNs may have been obtained e.g. from SMF 804. That handling may correspond to either Late or Early DNS handling.

In some aspects, as shown in FIG. 8, the process 800 may include a step 2a in which, if early DNS handling applies, the LDNSR 806 adds the IPv4 subnet or IPv4 address or IPv6 prefix provisioned by SMF 804 as ECS option as specified in IETF RFC 7871 and sends it to a C-DNS (e.g., a Service DNS) server 808 to convey UE IP location information. In some aspects, the C-DNS 808 may return a DNS response including one or more EAS FQDNs in priority order. In some aspects, each FQDN encoding may include distance to the site (or location information for the candidate EASs) identified in the prefix in the ECS (see section 2.3 above). In some aspects, these FQDNs with distance (or location) encodings may be sent as additional type A RRs (which is possible by standard DNS, see IETF RFC 1034 states (section 3.7.1.) including their corresponding EAS IP addresses as well). In some aspects, the step 2 may include the LDNSR 806 buffering the DNS query also for the Early DNS handling case to potentially resend it with a different ECS option if needed.

In some aspects, as shown in FIG. 8, the process 800 may include a step 3 in which the LDNSR 806 informs the SMF 804, which may trigger session re-anchoring if observing that re-anchoring is needed (e.g., in order to improve latency or to fit into a latency budget). In some aspects, the LDNSR 806 provides the FQDN in the UE query, the IP address(es) of the EAS selected by DNS, and the FQDNs in the DNS response. In some aspects, the FQDNs may include the distance information to the different EAS (sites). Thus, the SMF 804 is able to take the re-anchoring decision based on quantitative KPI estimates.

In some aspects, as shown in FIG. 8, the process 800 may include a step 3a in which, if early DNS handling is applied, then the DNS response is forwarded to the UE 802. The UE 802 may connect to the Edge AS via the Central PSA (UPF1).

In some aspects, as shown in FIG. 8, the process 800 may include a step 4 in which the SMF 804 decides on re-anchoring. In some aspects, the decision may be based on distance information received from the FQDNs received from the LDNSR 806. In some aspects, the SMF 804 may select the suitable EASs (e.g., those EASs that fulfil the distance criteria).

In some aspects, as shown in FIG. 8, the process 800 may include a step 4b in which the SMF 804 notifies back to the LDNSR 806 to drop the DNS query for late DNS handling with session and service continuity (SSC) mode 2 re-anchoring. In some aspects, the SMF 804 may additionally or alternatively notify the LDNSR 806 in the case when there is no EAS received that would fulfil the distance requirement, and the SMF 804 selects another candidate local PSA. In this case, the notification may include the ECN corresponding to the new PSA, and LDNSR 806 may initiate a new DNS query (i.e., re-start the procedure from step 2a) using the received ECN.

In some aspects, as shown in FIG. 8, the process 800 may include a step 5 in which the SMF 804 initiates a change of PDU session anchor to the PSA selected in step 4 (e.g., using SSC Mode 2 or SSC Mode 3 re-anchoring with the modifications described in clause 6.12.2 in 3GPP TR 23.748 v1.2.0. From this point on, the UE 802 may connect to the EAS via the local PSA 812 (UPF2).

In some aspects, as shown in FIG. 8, the process 800 may include a step 5a in which the SMF 804 responds to LDNSR 806 with the list of EAS FQDNs selected in step [00187] that fulfil the selection criteria including distance criterion.

In some aspects, as shown in FIG. 8, the process 800 may include a step 6 in which the LDNSR 806 sends a DNS response to UE 802. In some aspects, the response may include one or more EAS FQDNs or IP addresses in preference order.

In some aspects, the remaining steps from the sequence from clause 6.12.2 in 3GPP TR 23.748 v1.2.0 may be unchanged.

2.6 Example: LR functionality integrated into the NRF

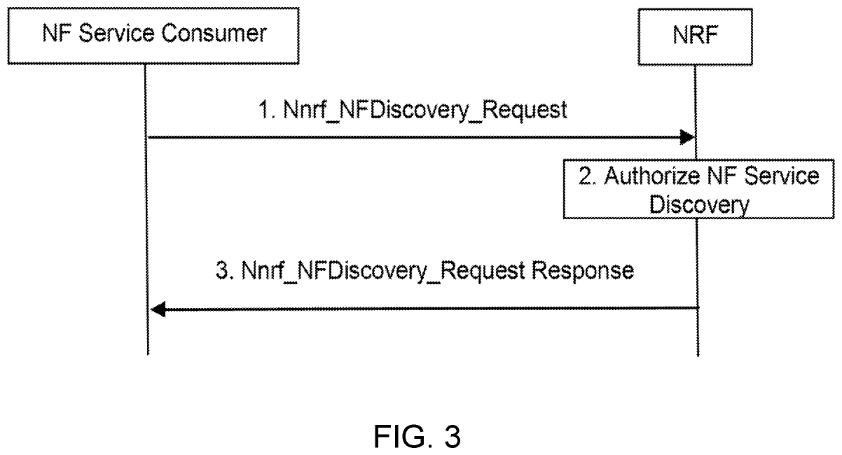

In some aspects, the LR functionality may be integrated into the network repository function (NRF). In these aspects, the peer selection unit 404 of FIG. 4 may include a network function (NF) service consumer, and the peer discovery unit 406 of FIG. 4 may include an NRF. In these aspects, the discovery procedure via NRF may still look like that depicted in FIG. 3. In some aspects, the NF service consumer may convey a request for an NF to the NRF. Although in some aspects the peer selection unit 404 may request a peer in the name of a source peer 402 different than the peer selection unit 404, in these NRF aspects, the NF service consumer as peer selection unit 404 may request a peer (e.g., NF) in its own name (e.g., for the NF service consumer to communicate with). Accordingly, the NRF as peer discovery unit 406 may already have the location of the requestor (e.g., the NF service consumer as peer selection unit 404) from the registration procedure. In some aspects, the LR of the NRF may use the location of the NF service consumer in the provisioning of the proper routing instances. In some aspects, the service operation in step 1 of FIG. 3 may be unchanged. In some aspects, the NRF may convey an NRF response to the NF service consumer. In some aspects, the NRF response may include distance information identifying routing distances from the candidate NFs to the location of the requester/NF service consumer. Accordingly, the distance information for a candidate NF that is included in an NRF response to a first requesting NF service consumer at a first location would be different than the distance information for the same candidate NF that is included in an NRF response to a second requesting NF service consumer at a different second location. In some aspects, the NRF may include the distance information in the operator-specific “location” attributes for the candidate NFs. In some aspects, the “location” attribute may include the distance information in addition to or instead of the value specified by the target NF during registration. In some aspects, the requesting NF service consumer may receive the distance information and use the distance information to select a target NF that is topologically close to the NF service consumer.

In some aspects, the discovery request may be enhanced by a new “location” attribute where the requesting NF service consumer could send the location of a source peer 402 for which the NF service consumer needs to perform the distance-based selection. By this extension and by using the proposed LR logic in the NRF, the NF service consumer may select a UPF for a DNAI and/or an LDNSR for an UPF, etc.

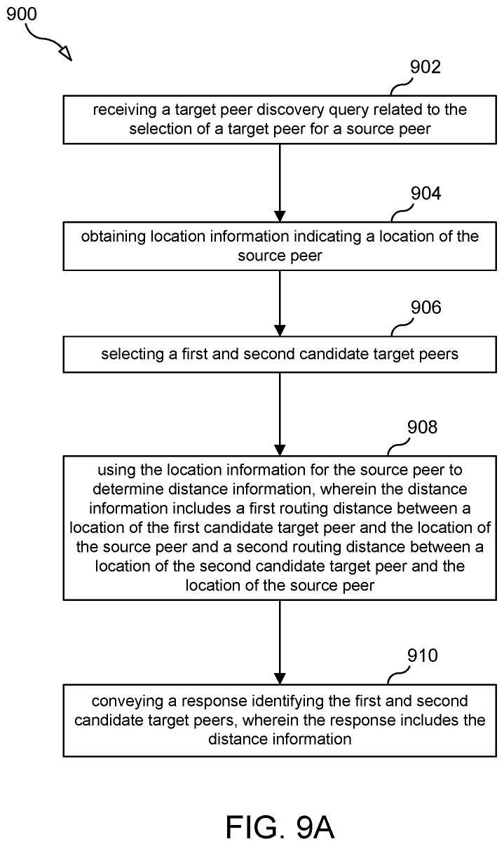

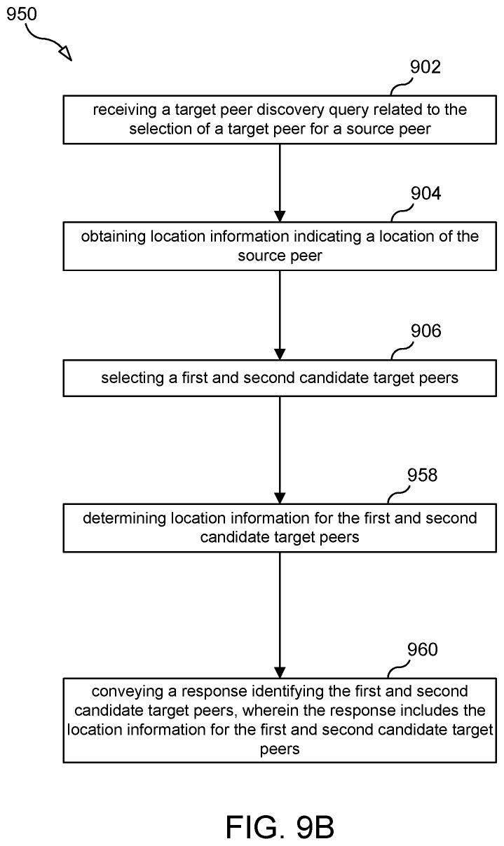

FIG. 9A illustrates a process 900 performed by a peer discovery unit 406 (e.g., DNS 606, C-DNS 708, C-DNS 808, or an NRF) according to some aspects.

In some aspects, the process 900 may include a step 902 in which the peer discovery unit 406 receives a target peer discovery query related to the selection of a target peer for a source peer 402. In some aspects, the target peer discovery query may be a domain name system (DNS) query. In some aspects, the source peer 402 may be a user equipment (UE) 702 or 802, a local PSA, a network function (NF), or an NF service consumer.

In some aspects, the process 900 may include a step 904 in which the peer discovery unit 406 obtains (e.g., receives from an external source or retrieves from an internal source such as a memory) location information indicating a location of the source peer 402. In some aspects, the location information for the source peer 402 may include an Internet Protocol (IP) address or address range. In some aspects, the location information may include coordinate information for the source peer 402, an identifier of the source peer 402 (e.g., identifying the source peer, a function provided by the source peer, a network slice, a sub-network, and/or a name space), and/or reference point distance information (e.g., including, for each of one or more reference points, a distance from the source peer 402 to the reference point).

In some aspects, the target peer discovery query may include the location information for the source peer. In some aspects, a DNS extension (EDNS) may include the location information for the source peer 402. In some aspects, the EDNS may be an EDNS client subnet (ECS) extension. In some aspects, a zero (Z) header of the DNS query may include the location information for the source peer 402. In some aspects, the target peer discovery query may include an identification of a target peer. In some aspects, the identification of the target peer may include the location information for the source peer. In some aspects, the identification of the target peer may include a fully qualified domain name (FQDN) of the target peer. In some aspects, the FQDN may include the location information for the source peer. In some aspects, an attribute of the target peer discovery query may include the location information.

In some aspects (e.g., some aspects in which the target peer discovery query includes the location information for the source peer), the location information may include encoding (e.g., site specific encoding). In some aspects, the encoding may be such that only the peer discovery unit 406 (e.g., an authoritative DNS and not an intermediate DNS) is capable of understanding the location information. In some aspects, the process 900 may include a step of decoding the location information. In some aspects, the encoding may protect privacy (e.g., so that an eavesdropper is unable to understand the location information). In some aspects, the encoding may additionally or alternatively prevent exposure of a content distribution network (CDN) mapping policy.

In some aspects, the process 900 may include a step 906 in which the peer discovery unit 406 selects at least first and second candidate target peers.

In some aspects, the process 900 may include a step 908 in which the peer discovery unit 406 uses the location information for the source peer to determine distance information. The distance information may include a first routing distance between a location of the first candidate target peer and the location of the source peer 402 and a second routing distance between a location of the second candidate target peer and the location of the source peer 402. In some aspects, the first and second routing distances may be in units of length. In some alternative aspects, the first and second routing distances may be in units of time. In some other alternative aspects, the first and second routing distances may use other metrics, such as, for example and without limitation, routing cost, hop count, path bandwidth, and/or path load. In some aspects, distances may be given in different units for different applications and/or distances may be given in multiple units (e.g., in the same message, and the peer selection unit 404 may decide which unit or metric is best suited in a given case). In some aspects, the first and second routing distances may be site location coordinates.

In some aspects in which the location information includes coordinate information for the source peer 402, in step 908, the peer discovery unit 406 may determine a first routing distance between a location of the first candidate target peer and the location of the source peer 402 using the coordinate information for the source peer and coordinate information for the first candidate target peer. In some aspects, in step 908, the peer discovery unit 406 may determine a second routing distance between a location of the second candidate target peer and the location of the source peer 402 using the coordinate information for the source peer and coordinate information for the second candidate target peer. In some aspects in which the location information includes coordinate information for the source peer 402, the coordinate information for the source peer 402 and the candidate target peers may be geographical coordinates, one-dimensional coordinates, or multi-dimensional coordinates (e.g., in Euclidian space).

In some aspects in which the location information includes reference point distance information, in step 908, the peer discovery unit 406 may determine a routing distance between a location of a candidate target peer and the location of the source peer 402 using the reference point distance information. In some aspects, determining the routing distance using the reference point distance information may include determining the sum of (i) the distance between the source peer and a reference point (which may be included in the location information received in step 503) and (ii) a distance between the reference point and the candidate target peer. In some aspects in which the location information includes distances from the source peer 402 to multiple reference points, determining the routing distance may include determining, for each of the multiple reference points, a routing distance between the candidate target peer and the source peer 402 via the reference point (e.g., as the sum of the received routing distance between the source peer 402 and the reference point and a routing distance between the reference point and the candidate target peer). In some aspects, the peer discovery unit 406 may use the shortest of the determined routing distances via the multiple reference points as the routing distance between a location of a candidate target peer and the location of the source peer using the reference point distance information.

In some aspects, using the location information for the source peer 402 to determine the distance information in step 908 may include using the location information for source peer 402 (e.g., an identifier of the source peer 402, a function provided by the source peer, a network slice, a sub-network, and/or a name space) to select entries in a table (e.g., to select a table and/or a row or column of a table) and reading the selected table entries as the first and second routing distances (e.g., reading the first and second routing distances from the selected table and/or the selected row or column of the table). In some aspects, routing distances of the table may be measured routing distances. In some aspects, the measured routing distances may be obtained by measurement probes at the locations of the candidate target peers. In some alternative aspects, the routing distances may be provided by an operation and management (O&M) program.

In some aspects, the process 900 may include a step 910 in which the peer discovery unit 406 conveys a response identifying the first and second candidate target peers. In some aspects, the response may include the distance information. In some aspects, an extension to the response may include the distance information. In some aspects, a zero (Z) header of the response may include the distance information. In some aspects, the response may include identifications of the first and second candidate target peers. In some aspects, the identifications of the first and second candidate target peers may include the first and second routing distances, respectively. In some aspects, the identifications of the first and second candidate target peers may include fully qualified domain names (FQDNs) of the first and second candidate target peers, respectively. In some aspects, the FQDNs of the first and second candidate target peers may include the first and second routing distances, respectively.

In some aspects, the first and second candidate target peers may be user plane functions (UPFs). In some aspects, the target peer discovery query may include an identification of a UPF. In some aspects, the identification of the UPF may include a data network name (DNN) and/or network slice.

In some aspects, the first and second candidate target peers may be edge application servers (EASs). In some aspects, the source peer 402 may by a local packet data unit (PDU) session anchor (PSA). In some aspects, the target peer discovery query received in step 902 may have been conveyed by a mobile network operator (MNO) domain name system (DNS), the location information may be an Internet Protocol (IP) address of the source peer 402, the response conveyed in step 910 may include IP addresses that identify the EASs, and the first and second routing distances may be between the EASs and the location of the source peer. In some aspects, the target peer discovery query received in step 902 may have been conveyed by a local domain name system resolver (LDNSR), the response conveyed in step 910 may include IP addresses that identify the EASs, and the first and second routing distances may be between the EASs and the location of the source peer 402.

In some aspects, the peer discovery unit may be a network repository function (NRF), the first and second candidate target peers may be network functions (NFs), and the first and second routing distances may be between the NFs and the location of the source peer 402. In some aspects, the source peer 402 may be an NF service consumer. In some aspects, the target peer discovery query received in step 902 may be conveyed by the NF service consumer. In some aspects, the target peer discovery query may include the location information for the NF service consumer. In some aspects, the NRF may already have location information for the NF service consumer, and the target peer discovery query may not include location information. In some alternative aspects, the NF service consumer may request discovery of an NF for another entity (e.g., an SMF requesting a UPF from the NRF), and, in these aspects, the source peer 402 may be other entity, the target peer discovery query may include location information for the other entity (e.g., a UE), and the distance information may relate to the routing distances may be between candidate target NFs and the other entity (e.g., a UE-UPF distance). In some aspects, the NFs and the NRF may be part of a 5G Core (5GC) control plane defined as part of a service-based architecture (SBA).

FIG. 9B illustrates a process 950 performed by a peer discovery unit 406 (e.g., DNS 606, C-DNS 708, C-DNS 808, or an NRF) according to some aspects. In some aspects, the process 950 may include one or more of steps 902, 904, and 906, which may be the same as step 902, 904, and 906, respectively, of the process 900 illustrated in FIG. 9A.

In some aspects, the process 950 may include a step 958 in which the peer discovery unit 406 determines location information for the first and second candidate target peers. In some aspects, the location information for the candidate target peers may include coordinates for the candidate target peers and/or routing distances between the candidate target peers and one or more reference points (e.g., one or more reference points in the location information for the source peer 402). In some aspects, the peer discovery unit 406 may use the location information for the source peer 402 to determine location information for the first and second candidate target peers (e.g., determine routing distances from the candidate target peers to each of the one or more reference points in the location information for the source peer 402).

In some aspects, the process 950 may include a step 960 in which the peer discovery unit 406 conveys a response identifying the first and second candidate target peers. In some aspects, the response may include the location information for the first and second candidate target peers. In some aspects, an extension to the response may include the location information for the first and second candidate target peers. In some aspects, a zero (Z) header of the response may include the location information for the first and second candidate target peers. In some aspects, the response may include identifications of the first and second candidate target peers. In some aspects, the identifications of the first and second candidate target peers may include the location information for the first and second candidate target peers, respectively. In some aspects, the identifications of the first and second candidate target peers may include fully qualified domain names (FQDNs) of the first and second candidate target peers, respectively. In some aspects, the FQDNs of the first and second candidate target peers may include the location information for the first and second candidate target peers, respectively.

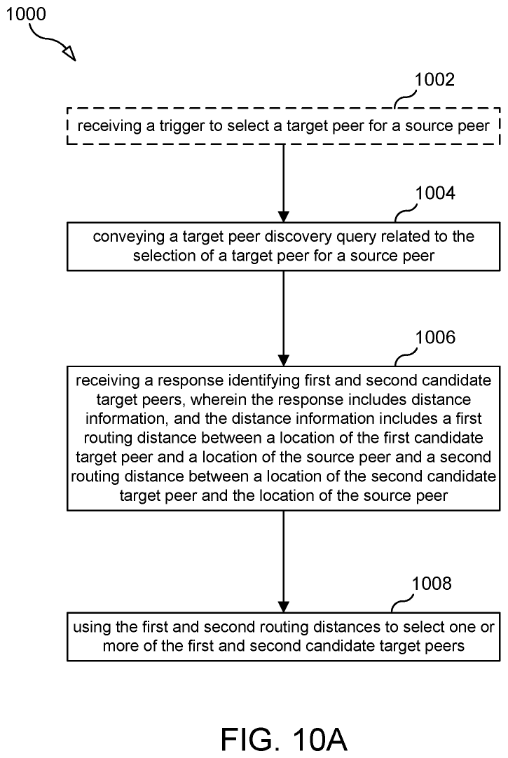

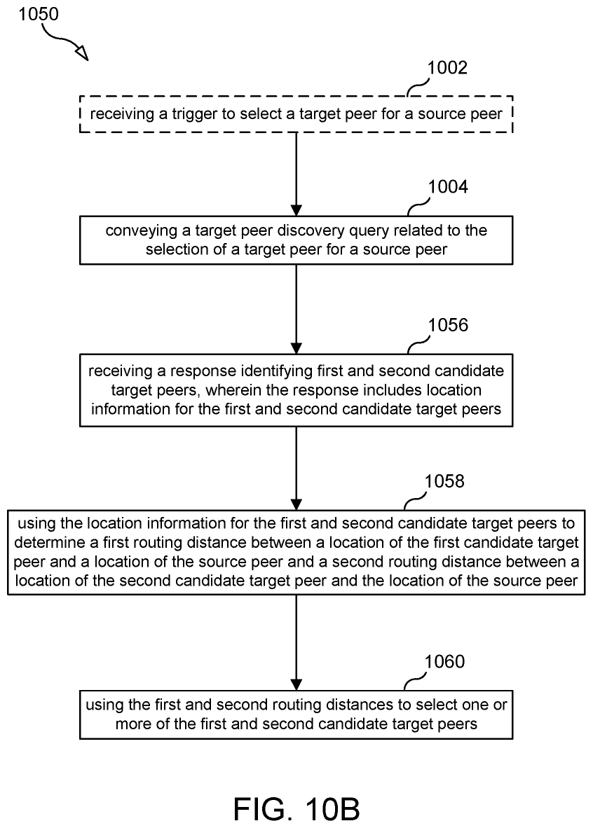

FIG. 10A illustrates a process 1000 performed by a peer selection unit 404 (e.g., an SMF 704 or 804 or an NF service consumer) according to some aspects.

In some aspects, the process 1000 may include an optional step 1002 in which the peer selection unit 404 receives a trigger to select a target peer. In some aspects, the trigger may include an identification of the target peer. In some aspects, the identification of the target peer may be a fully qualified domain name (FQDN). In some aspects, the process 1000 may include an optional step in which the peer selection unit 404 obtains (receives or retrieves) location information for the source peer (either in the optional step 1002 or in a separate step). In some aspects, the location information may include coordinate information for the source peer 402, an identifier of the source peer 402 (e.g., identifying the source peer, a function provided by the source peer, a network slice, a sub-network, and/or a name space), and/or reference point distance information (e.g., including, for each of one or more reference points, a distance from the source peer 402 to the reference point).

In some aspects, the process 1000 may include a step 1004 in which the peer selection unit 404 conveys a target peer discovery query related to the selection of a target peer for a source peer 402. In some aspects, the source peer 402 may be a user equipment (UE) 702 or 802, a local PSA, a network function (NF), or an NF service consumer.

In some aspects, the target peer discovery query may include the location information for the source peer 402. In some aspects, the target peer discovery query may include an identification of a target peer. In some aspects, the identification of the target peer may include the location information for the source peer 402. In some aspects, the identification of the target peer may include a fully qualified domain name (FQDN) of the target peer. In some aspects, the FQDN may include location information for the source peer 402. In some aspects, the location information for the source peer 402 may include an Internet Protocol (IP) address or address range.

In some aspects (e.g., some aspects in which the target peer discovery query includes the location information for the source peer), the location information may include encoding (e.g., site specific encoding). In some aspects, the encoding may be such that only the peer discovery unit 406 (e.g., an authoritative DNS and not an intermediate DNS) is capable of understanding the location information. In some aspects, the process 1000 may include a step of encoding the location information. In some aspects, the encoding may protect privacy (e.g., so that an eavesdropper is unable to understand the location information). In some aspects, the encoding may additionally or alternatively prevent exposure of a content distribution network (CDN) mapping policy.

In some aspects, the target peer discovery query conveyed in step 1004 may be a domain name system (DNS) query. In some aspects, the process 1000 may further include (e.g., in step 1002 or in a separate step) conveying a DNS extension (EDNS) including the location information for the source peer 402. In some aspects, the EDNS may be an EDNS client subnet (ECS) extension. In some aspects, a zero (Z) header of the DNS query may include location information for the source peer 402.

In some aspects, the process 1000 may include a step 1006 in which the peer selection unit 404 receives a response identifying the first and second candidate target peers. The response may include distance information. The distance information may include a first routing distance between a location of the first candidate target peer and the location of the source peer 402 and a second routing distance between a location of the second candidate target peer and the location of the source peer 402. In some aspects, the first and second routing distances may be in units of length. In some alternative aspects, the first and second routing distances may be in units of time. In some other alternative aspects, the first and second routing distances may use other metrics, such as, for example and without limitation, routing cost, hop count, path bandwidth, and/or path load. In some aspects, distances may be given in different units for different applications and/or distances may be given in multiple units (e.g., in the same message, and the peer selection unit 404 may decide which unit or metric is best suited in a given case). In some aspects, the first and second routing distances are site location coordinates.

In some aspects, an extension to the response may include the distance information. In some aspects, a zero (Z) header of the response may include the distance information. In some aspects, the response may include identifications of the first and second candidate target peers. In some aspects, the identifications of the first and second candidate target peers may include the first and second routing distances, respectively. In some aspects, the identifications of the first and second candidate target peers may include fully qualified domain names (FQDNs) of the first and second candidate target peers, respectively. In some aspects, the FQDNs of the first and second candidate target peers may include the first and second routing distances, respectively.

In some aspects, the process 1000 may include a step 1008 in which the peer selection unit 404 uses the first and second routing distances to select one or more of the first and second candidate target peers.

FIG. 10B illustrates a process 1050 performed by a peer selection unit 404 (e.g., an SMF 704 or 804 or an NF service consumer) according to some aspects. In some aspects, the process 1050 may include step 1002 and/or step 1004, which may be the same as the steps 1002 and 1004, respectively, of the process 1000.

In some aspects, the process 1050 may include a step 1056 in which the peer selection unit 404 receives a response identifying at least first and second candidate target peers. The response may include location information for the first and second candidate target peers. In some aspects, the location information for the candidate target peers may include coordinates for the first and second candidate target peers and/or reference point distance information for the first and second candidate target peers.

In some aspects, an extension to the response may include the location information for the first and second candidate target peers. In some aspects, a zero (Z) header of the response may include the location information for the first and second candidate target peers. In some aspects, the response may include identifications of the first and second candidate target peers. In some aspects, the identifications of the first and second candidate target peers may include the location information for the first and second candidate target peers, respectively. In some aspects, the identifications of the first and second candidate target peers may include fully qualified domain names (FQDNs) of the first and second candidate target peers, respectively. In some aspects, the FQDNs of the first and second candidate target peers may include the location information for the first and second candidate target peers, respectively.

In some aspects, the process 1050 may include a step 1058 in which the peer selection unit 404 uses the location information for the first and second candidate target peers to determine distance information including a first routing distance between a location of the first candidate target peer and the location of the source peer 402 and a second routing distance between a location of the second candidate target peer and the location of the source peer 402.

In some aspects in which the location information for the first and second candidate target peers includes coordinate information for the first and second candidate target peers, in step 1058, the peer selection unit 404 may determine the first routing distance between a location of the first candidate target peer and the location of the source peer 402 using the coordinate information for the source peer and coordinate information for the first candidate target peer. In some aspects, in step 1058, the peer selection unit 404 may determine the second routing distance between a location of the second candidate target peer and the location of the source peer 402 using the coordinate information for the source peer and coordinate information for the second candidate target peer. In some aspects in which the location information includes coordinate information for the source peer 402, the coordinate information for the source peer 402 and the candidate target peers may be geographical coordinates, one-dimensional coordinates, or multi-dimensional coordinates (e.g., in Euclidian space).

In some aspects in which the location information for the first and second candidate target peers includes reference point distance information for the first and second candidate target peers, the reference point distance information may include a routing distance between the first candidate target peer and each of one or more reference points and a routing distance between the second candidate target peer and each of the one or more reference points. In some aspects, the one or more reference points may be the same as the one or more reference points in the location information for the source peer 402. In some aspects, the routing distances between the candidate target peers and the one or more reference points may be in units of length. In some alternative aspects, the routing distances between the candidate target peers and the one or more reference points may be in units of time. In some other alternative aspects, the routing distances may use other metrics, such as, for example and without limitation, routing cost, hop count, path bandwidth, and/or path load. In some aspects, distances may be given in different units for different applications and/or distances may be given in multiple units (e.g., in the same message, and the peer selection unit 404 may decide which unit or metric is best suited in a given case).

In some aspects, in step 1058, the peer selection unit 404 may determine a first routing distance between a location of the first candidate target peer and the location of the source peer 402 and a second routing distance between a location of the second candidate target peer and the location of the source peer 402 using the reference point distance information. In some aspects, determining the first routing distance may include determining the sum of (i) the routing distance between the source peer 402 and a reference point and (ii) the routing distance between the reference point and the first candidate target peer. In some aspects, determining the second routing distance may include determining the sum of (i) the routing distance between the source peer 402 and a reference point and (ii) the routing distance between the reference point and the second candidate target peer.

In some aspects in which the reference point distance information includes distances from the candidate target peers to multiple reference points, determining the routing distance may include determining, for each of the multiple reference points, a routing distance between the candidate target peer and the source peer 402 via the reference point (e.g., as the sum of the routing distance between the source peer 402 and the reference point and the received routing distance between the reference point and the candidate target peer). In some aspects, the peer discovery unit 406 may use the shortest of the determined routing distances via the multiple reference points as the routing distance between a location of a candidate target peer and the location of the source peer using the reference point distance information.

In some aspects, the process 1050 may include a step 1060 in which the peer selection unit 404 uses the first and second routing distances to select one or more of the first and second candidate target peers.

In some aspects, the first and second candidate target peers may be user plane functions (UPFs). In some aspects, the process 1000 and/or 1050 may include an optional step in which the peer selection unit 404 receives a packet data unit (PDU) session establishment request. In some aspects, the source peer may be a user equipment (UE), and the process 1000 and/or 1050 may include an optional step in which the peer selection unit 404 receives location information for the UE. In some aspects, the location information for the UE may include a tracking area identifier (TAI) and cell identification (ID). In some aspects, the location information for the UE may be received in a packet data unit (PDU) session establishment request. In some aspects, the location information for the UE may be included in the target peer discovery query conveyed in step 1004. In some aspects, the target peer discovery query may include a fully qualified domain name (FQDN) of a UPF, and the FQDN of the UPF may include the location information for the UE. In some aspects, the FQDN of the UPF may include a data network name (DNN) and/or network slice. In some aspects, using the first and second routing distances to select one of the first and second candidate target peers may include selecting a UPF of a cluster that is located closest to the UE.

In some aspects, the first and second candidate target peers may be edge application servers (EASs). In some aspects, the source peer 402 may be a local packet data unit (PDU) session anchor (PSA). In some aspects, the target peer discovery query conveyed in step 1004 may include an Internet Protocol (IP) address of the source peer, the response received in step 1006 may include IP addresses that identify the EASs, and the first and second routing distances may be between the EASs and the location of the source peer 402. In some aspects, the response may include Internet Protocol (IP) addresses that identify the EASs, and the first and second routing distances may be between the EASs and the location of the source peer 402. In some aspects, the first and second routing distances may be included in fully qualified domain names (FQDNs). In some aspects, using the first and second routing distances to select one or more of the first and second candidate target peers in step 1008 and/or using the location information for the first and second candidate target peers in step 1060 may include determining that one or more of the first and second candidate target peers meets distance criteria. In some aspects, using the first and second routing distances to select one or more of the first and second candidate target peers may include selecting a data network access identifier (DNAI) and a local packet data unit (PDU) session anchor (PSA) at a location identified by the DNAL In some aspects, using the first and second routing distances to select one or more of the first and second candidate target peers in step 1008 and/or 1060 may include determining that the selected local PSA and the selected one or more of the first and second candidate target peers correspond to the selected DNAI. In some aspects, the process 1000 and/or 1050 may include optional steps in which the peer selection unit 404 uses the first and second routing distances to decide to change a local packet data unit (PDU) session anchor (PSA) to a new local PSA, selects a new local PSA, and initiates a change of local PSA to the selected new local PSA.

In some aspects, the process 1000 and/or 1050 may include an optional step of conveying the selected one or more of the first and second candidate target peers to a local domain name system resolver (LDNSR) 706 or 806. In some aspects, the peer selection unit may be a session management function (SMF) 704 or 804. In some aspects, the process 1000 and/or 1050 may include deferring selection of a new local PSA (either by re-anchoring or local breakout) if none of the first and second candidate target peers meets distance criteria.

In some aspects, the peer selection unit 404 may be a network function (NF) service consumer, the first and second candidate target peers may be network functions (NFs), the first and second routing distances may be between the NFs and the location of the source peer 402, and using the first and second routing distances to select one or more of the first and second candidate target peers in step 1008 and/or 1060 may include selecting a candidate target NF that is topologically close to the NF service consumer. In some aspects, the source peer 402 may be the NF service consumer. In some aspects, the target peer discovery query conveyed in step 1004 may include location information for the NF service consumer. In some alternative aspects, the NF service consumer may request discovery of an NF for another entity (e.g., an SMF requesting a UPF from the NRF), and, in these aspects, the source peer 402 may be other entity, the target peer discovery query may include location information for the other entity (e.g., a UE), and the distance information may relate to the routing distances may be between candidate target NFs and the other entity (e.g., a UE-UPF distance). In some aspects, the NFs may be part of a 5G Core (5GC) control plane defined as part of a service-based architecture (SBA).

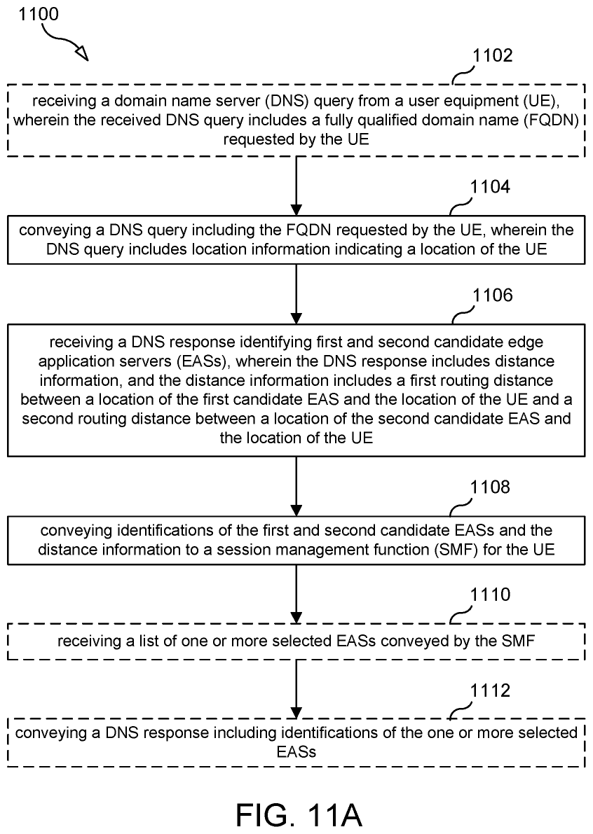

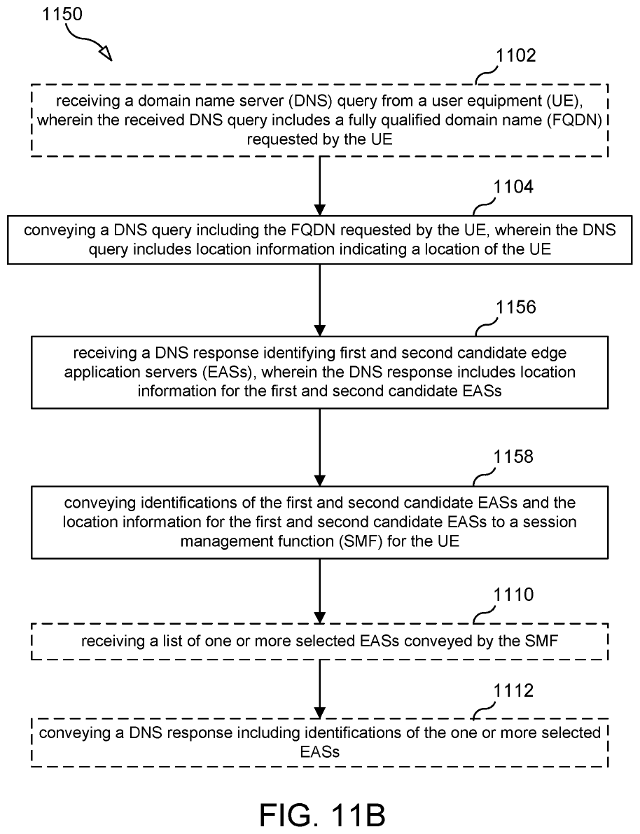

FIG. 11A illustrates a process 1100 performed by a local domain name server resolver (LDNSR) (e.g., LDNSR 706 or 806) according to some aspects.

In some aspects, the process 1100 may include an optional step 1102 in which the LDNSR receives a domain name server (DNS) query from a user equipment (UE) 702 or 802. In some aspects, the received DNS query may include an FQDN requested by UE. In some aspects, the step 1102 may include the LDNSR modifying the received DNS query to create a DNS query to be conveyed in step 1104. In some aspects, modifying the received DNS query may include adding location information indicating the location of the UE.

In some aspects, the process 1100 may include a step 1104 in which the LDNSR conveys a domain name server (DNS) query including a fully qualified domain name (FQDN) requested by a user equipment (UE) 702 or 802. The DNS query may include location information indicating a location of the UE 702 or 802. In some aspects, for a mobile UE, the location information may indicate the location of the UE 702 or 802 by indicating a fixed point in proximity to the UE (e.g., a cell serving the UE 702 or 802 or a tracking area identity (TAI) for the UE 702 or 802). In some aspects, the location information may include coordinate information for the UE, an identifier of the UE (e.g., identifying the UE, a cell serving the UE, a tracking area identity (TAI) for the UE, a function provided by the UE, a network slice, a sub-network, and/or a name space), and/or reference point distance information (e.g., including, for each of one or more reference points, a distance from the UE to the reference point). In some aspects, the FQDN of the DNS query conveyed in step 1104 may include the location information. In some alternative aspects, a DNS extension (EDNS) to the DNS request conveyed in step 1104 may include the location information. In some aspects, the EDNS may be an EDNS client subnet (ECS) extension. In some alternative aspects, a zero (Z) header of the DNS query conveyed in step 1104 may include the location information.

In some aspects (e.g., some aspects in which the DNS query conveyed in step 1104 includes the location information indicating a location of the UE 702), the location information may include encoding (e.g., site specific encoding). In some aspects, the encoding may be such that only the C-DNS 708 or 808 (e.g., an authoritative DNS and not an intermediate DNS) is capable of understanding the location information. In some aspects, the process 1100 may include a step of encoding the location information. In some aspects, the encoding may protect privacy (e.g., so that an eavesdropper is unable to understand the location information). In some aspects, the encoding may additionally or alternatively prevent exposure of a content distribution network (CDN) mapping policy.

In some aspects, the location information indicating the location of the UE may include an Internet Protocol (IP) address or address range. In some aspects, the IP address or address range of the location information may correspond to a data network access identifier (DNAI) and/or a local packet data unit (PDU) session anchor (PSA) selected by a session management function (SMF) 704 or 804 for the location of the UE.

In some aspects, the process 1100 may include a step 1106 in which the LDNSR receives a DNS response identifying first and second candidate edge application servers (EASs). The DNS response may include distance information, and the distance information may include a first routing distance between a location of the first candidate EAS and the location of the UE and a second routing distance between a location of the second candidate EAS and the location of the UE.

In some aspects, an extension to the DNS response may include the distance information. In some alternative aspects, a zero (Z) header of the response may include the distance information. In some alternative aspects, the identifications of the first and second candidate EASs may include the first and second routing distances, respectively. In some aspects, the identifications of the first and second candidate EASs may include FQDNs of the first and second candidate EASs, respectively. In some aspects, the FQDNs of the first and second candidate EASs may include the first and second routing distances, respectively.

In some aspects, the process 1100 may include a step 1108 in which the LDNSR conveys identifications of the first and second candidate EASs and the distance information to a session management function (SMF) 704 or 804 for the UE.

FIG. 11B illustrates a process 1150 performed by a local domain name server resolver (LDNSR) (e.g., LDNSR 706 or 806) according to some aspects. In some aspects, the process 1150 may include a step 1102 and/or a step 1104, which may be the same as the steps 1102 and 1104, respectively, of the process 1100 illustrated in FIG. 11A.

In some aspects, the process 1150 may include a step 1156 in which the LDNSR receives a DNS response identifying first and second candidate edge application servers (EASs). The DNS response may include location information for the first and second candidate EASs. In some aspects, the location information for the first and second candidate EASs may include coordinates for the first and second candidate EASs and/or reference point distance information for the first and second candidate EASs.

In some aspects, an extension to the DNS response may include the location information for the first and second candidate EASs. In some alternative aspects, a zero (Z) header of the response may include the location information for the first and second candidate EASs. In some alternative aspects, the identifications of the first and second candidate EASs may include the location information for the first and second candidate EASs, respectively. In some aspects, the identifications of the first and second candidate EASs may include FQDNs of the first and second candidate EASs, respectively. In some aspects, the FQDNs of the first and second candidate EASs may include the location information for the first and second candidate EASs, respectively.

In some aspects, the process 1150 may include a step 1158 in which the LDNSR conveys identifications of the first and second candidate EASs and the location information for the first and second candidate EASs to a session management function (SMF) 704 or 804 for the UE.

In some aspects, the process 1100 and/or 1150 may include an optional step 1110 in which the LDNSR receives a list of one or more selected EASs conveyed by the SMF 704 or 804. In some aspects, the process 1100 and/or 1150 may include an optional step 1112 in which the LDNSR conveys a DNS response including identifications of the one or more selected EASs. In some aspects, the list of one or more selected EASs may include FQDNs of the one or more selected EASs. In some aspects, the identifications of the one or more selected EASs may include Internet Protocol (IP) addresses and/or FQDNs of the one or more selected EASs.

In some aspects, the process 1100 and/or 1150 may include optional steps in which the LDNSR buffers the conveyed DNS query for early DNS handling and conveys the buffered DNS query with a different DNS extension (EDNS) client subnet (ECS) option.

In some aspects, the process 1100 and/or 1150 may include an optional step 1112 in which the LDNSR conveys the FQDN requested by the UE to the SMF.

In some aspects, the process 1100 and/or 1150 may include an optional step in which the LDNSR receives an identification of a candidate local packet data unit (PDU) session anchor (PSA). In some aspects, the process 1100 and/or 1150 may include an optional step in which the LDNSR conveys a second DNS query, the second DNS query may include location information corresponding to the location of the candidate local PSA. In some aspects, the process 1100 and/or 1150 may include an optional step in which the LDNSR receives a second DNS response identifying candidate EASs, the DNS response may include second distance information (or second location information for the candidate EASs), and the second distance information may include routing distances between locations of the candidate EASs and the location of the candidate local PSA (or the second location information for the candidate EASs may include coordinates for the candidate EASs and/or reference point distance information for the candidate EASs). In some aspects, the process 1100 and/or 1150 may include an optional step in which the LDNSR conveys identifications of the candidate EASs and the second distance information (or the second location information for the candidate EASs) to the SMF.

Although the aspects described above with reference to FIGS. 9A-11B explicitly include first and second candidate target peers included in the responses, the responses may include more than two (e.g., three, four, five, ten, fifteen, twenty, etc.) candidate target peers for consideration by the peer selection unit 404.

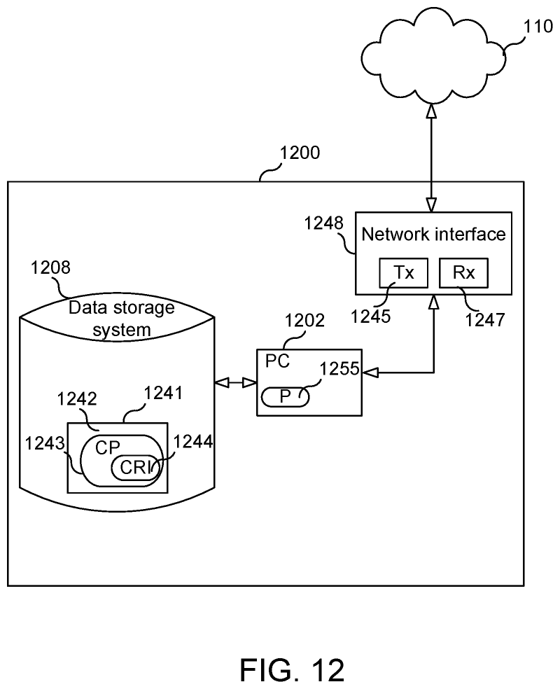

FIG. 12 is a block diagram of an apparatus 1200 (e.g., peer selection unit 404, peer discovery unit 406, DNS 606, SMF 704, LDNSR 706, C-DNS 708, SMF 804, LDNSR 806, C-DNS 808, UPF 810, UPF 812, or an NRF) according to some aspects. As shown in FIG. 12, the apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248 comprising a transmitter (Tx) 1245 and a receiver (Rx) 1247 for enabling apparatus 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a storage unit (a.k.a., “data storage system”) 1208, which may include one or more non-volatile storage devices and/or one or more volatile storage devices. In aspects where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some aspects, the CRI 1244 of computer program 1243 is configured such that when executed by PC 1202, the CRI causes the apparatus 1200 to perform steps described herein (e.g., steps described herein with reference to the flow charts). In other aspects, the apparatus 1200 may be configured to perform steps described herein without the need for code. That is, for example, PC 1202 may consist merely of one or more ASICs. Hence, the features of the aspects described herein may be implemented in hardware and/or software.

### SUMMARY OF EMBODIMENTS

A1. A method performed by a peer discovery unit (406), the method comprising: receiving a target peer discovery query related to the selection of a target peer for a source peer (402); obtaining location information indicating a location of the source peer; selecting first and second candidate target peers; using the location information for the source peer to determine distance information, wherein the distance information includes a first routing distance between a location of the first candidate target peer and the location of the source peer and a second routing distance between a location of the second candidate target peer and the location of the source peer; and conveying a response identifying the first and second candidate target peers, wherein the response includes the distance information.

A2. The method of embodiment A1, wherein the target peer discovery query includes the location information for the source peer.

A3. The method of embodiment A1 or A2, wherein the target peer discovery query includes an identification of a target peer.

A4. The method of embodiment A3, wherein the identification of the target peer includes the location information for the source peer.

A5. The method of embodiment A3 or A4, wherein the identification of the target peer includes a fully qualified domain name (FQDN) of the target peer.

A6. The method of embodiment A5, wherein the FQDN includes the location information for the source peer.

A7. The method of any one of embodiments A1-A6, wherein the location information for the source peer includes an Internet Protocol (IP) address or address range.

A8. The method of any one of embodiments A1-A7, wherein the target peer discovery query is a domain name system (DNS) query.

A9. The method of embodiment A8, wherein a DNS extension (EDNS) includes the location information for the source peer.

A10. The method of embodiment A9, wherein the EDNS is an EDNS client subnet (ECS) extension.

A11. The method of embodiment A8, wherein a zero (Z) header of the DNS query includes the location information for the source peer.

A12. The method of any one of embodiments A1-A8, wherein an attribute of the target peer discovery query includes the location information.

A13. The method of any one of embodiments A1-A12, wherein the first and second routing distances are in units of length.

A14. The method of any one of embodiments A1-A12, wherein the first and second routing distances are in units of time.

A15. The method of any one of embodiments A1-A14, wherein using the location information for the source peer to determine the distance information comprises using the location information for source peer to select a row or column of a table and reading the first and second routing distances from the selected row or column of the table.

A16. The method of embodiment A15, wherein routing distances of the table are measured routing distances.

A17. The method of embodiment A16, wherein the measured routing distances were obtained by measurement probes at the locations of the candidate target peers.

A18. The method of embodiment A15, wherein the routing distances are provided by an operation and management (O&M) program.

A19. The method of any one of embodiments A1-A18, wherein an extension to the response includes the distance information.

A20. The method of any one of embodiments A1-A19, wherein a zero (Z) header of the response includes the distance information.

A21. The method of any of embodiments A1-A19, wherein the response includes identifications of the first and second candidate target peers.

A22. The method of embodiment A21, wherein the identifications of the first and second candidate target peers include the first and second routing distances, respectively.

A23. The method of embodiment A21 or A22, wherein the identifications of the first and second candidate target peers include fully qualified domain names (FQDNs) of the first and second candidate target peers, respectively.

A24. The method of embodiment A23, wherein the FQDNs of the first and second candidate target peers include the first and second routing distances, respectively.

A25. The method of any one of embodiments A1-A24, wherein the first and second routing distances are site location coordinates.

A26. The method of any one of embodiments A1-A25, wherein the peer discovery unit is a domain name system (DNS).

A27. The method of any one of embodiments A1-A26, wherein the peer discovery unit is a central domain name system (C-DNS) server.

A28. The method of any one of embodiments A1-A27, wherein the source peer is a user equipment (UE).

A29. The method of any one of embodiments A1-A28, wherein the first and second candidate target peers are user plane functions (UPFs).

A30. The method of embodiments A29, wherein the target peer discovery query includes an identification of a UPF.

A31. The method of embodiment A30, wherein the identification of the UPF includes a data network name (DNN) and/or network slice.

A32A. The method of any one of embodiments A1-A28, wherein the first and second candidate target peers are edge application servers (EASs).

A32B. The method of embodiments A32A, wherein the source peer is a local packet data unit (PDU) session anchor (PSA).

A33. The method of embodiment A32A or A32B, wherein the target peer discovery query was conveyed by a mobile network operator (MNO) domain name system (DNS), the location information is an Internet Protocol (IP) address of the source peer, the response includes IP addresses that identify the EASs, and the first and second routing distances are between the EASs and the location of the source peer.

A34. The method of any one of embodiments A32A-A33, wherein the target peer discovery query was conveyed by a local domain name system resolver (LDNSR), the response includes IP addresses that identify the EASs, and the first and second routing distances are between the EASs and the location of the source peer.

A35. The method of any one of embodiments A1-A28, wherein the peer discovery unit (406) is a network repository function (NRF), and the first and second candidate target peers are network functions (NFs), and the first and second routing distances are between the NFs and the location of the source peer.

A36. The method of embodiment A35, wherein the source peer is an NF service consumer.

A37. The method of embodiment A36, wherein the target peer discovery query is conveyed by the NF service consumer.

A38. The method of any one of embodiments A35-A37, wherein the NFs and the NRF are part of a 5G Core (5GC) control plane defined as part of a service-based architecture (SBA).

B1. A peer discovery unit (406) adapted to: receive a target peer discovery query related to the selection of a target peer for a source peer (402); obtain location information indicating a location of the source peer; select first and second candidate target peers; use the location information for the source peer to determine distance information, wherein the distance information includes a first routing distance between a location of the first candidate target peer and the location of the source peer and a second routing distance between a location of the second candidate target peer and the location of the source peer; and convey a response identifying the first and second candidate target peers, wherein the response includes the distance information.

C1. A method performed by a peer selection unit (404), the method comprising: conveying a target peer discovery query related to the selection of a target peer for a source peer (402); receiving a response identifying first and second candidate target peers, wherein the response includes distance information, and the distance information includes a first routing distance between a location of the first candidate target peer and a location of the source peer and a second routing distance between a location of the second candidate target peer and the location of the source peer; and using the first and second routing distances to select one or more of the first and second candidate target peers.

C2. The method of embodiment C1, wherein the target peer discovery query includes location information for the source peer.

C3. The method of embodiment C1 or C2, wherein the target peer discovery query includes an identification of a target peer.

C4. The method of embodiment C3, wherein the identification of the target peer includes the location information for the source peer.

C5. The method of embodiment C3 or C4, wherein the identification of the target peer includes a fully qualified domain name (FQDN) of the target peer.

C6. The method of embodiment C5, wherein the FQDN includes location information for the source peer.

C7. The method of any one of embodiments C2-C6, wherein the location information for the source peer includes an Internet Protocol (IP) address or address range.

C8. The method of any one of embodiments C1-C7, wherein the target peer discovery query is a domain name system (DNS) query.

C9. The method of embodiment C8, further comprising conveying a DNS extension (EDNS) including location information for the source peer.

C10. The method of embodiment C9, wherein the EDNS is an EDNS client subnet (ECS) extension.

C11. The method of embodiment C8, wherein a zero (Z) header of the DNS query includes location information for the source peer.

C12. The method of any one of embodiments C1-C11, wherein the first and second routing distances are in units of length.

C13. The method of any one of embodiments C1-C11, wherein the first and second routing distances are in units of time.

C14. The method of any one of embodiments C1-C13, further comprising receiving a trigger to select a target peer.

C15. The method of embodiment C14, wherein the trigger includes an identification of the target peer.

C16. The method of embodiment C15, wherein the identification of the target peer is a fully qualified domain name (FQDN).

C17. The method of any one of C1-C16, further comprising obtaining location information for the source peer.

C18. The method of any one of embodiments C1-C17, wherein an extension to the response includes the distance information.

C19. The method of any one of embodiments C1-C18, wherein a zero (Z) header of the response includes the distance information.

C20. The method of any of embodiments C1-C19, wherein the response includes identifications of the first and second candidate target peers.

C21. The method of embodiment C20, wherein the identifications of the first and second candidate target peers include the first and second routing distances, respectively.

C22. The method of embodiment C20 or C21, wherein the identifications of the first and second candidate target peers include fully qualified domain names (FQDNs) of the first and second candidate target peers, respectively.

C23. The method of embodiment C22, wherein the FQDNs of the first and second candidate target peers include the first and second routing distances, respectively.

C24. The method of any one of embodiments C1-C23, wherein the first and second routing distances are site location coordinates.

C25. The method of any one of embodiments C1-C24, wherein the source peer is a user equipment (UE).

C26. The method of embodiment C25, wherein the first and second candidate target peers are user plane functions (UPFs).

C27A. The method of embodiment C26, further comprising receiving a packet data unit (PDU) session establishment request.

C27B. The method of embodiment C26 or C27A, further comprising receiving location information for the UE.

C28. The method of embodiment C27B, wherein the location information for the UE includes a tracking area identifier (TAI) and cell identification (ID).

C29. The method of embodiment C27B or C28, wherein the location information for the UE is received in a packet data unit (PDU) session establishment request.

C30. The method of any one of embodiments C27B-C29, wherein the location information for the UE is included in the target peer discovery query.

C31. The method of embodiment C30, wherein the target peer discovery query includes a fully qualified domain name (FQDN) of a UPF, and the FQDN of the UPF includes the location information for the UE.

C32. The method of embodiment C31, wherein the FQDN of the UPF includes a data network name (DNN) and/or network slice.

C33. The method of any one of embodiments C26-C32, wherein using the first and second routing distances to select one of the first and second candidate target peers comprises selecting a UPF of a cluster that is located closest to the UE.

C34A. The method of any one of embodiments C1-C28, wherein the first and second candidate target peers are edge application servers (EASs).

C34B. The method of embodiments C34A, wherein the source peer is a local packet data unit (PDU) session anchor (PSA).

C35. The method of embodiment C34A or C34B, wherein the target peer discovery query includes an Internet Protocol (IP) address of the source peer, the response includes IP addresses that identify the EASs, and the first and second routing distances are between the EASs and the location of the source peer.

C36. The method of embodiment C34A or C34B, wherein the response includes Internet Protocol (IP) addresses that identify the EASs, and the first and second routing distances are between the EASs and the location of the source peer.

C37. The method of embodiments C35 or C36, wherein the first and second routing distances are included in fully qualified domain names (FQDNs).

C38. The method of any one of embodiments C34A-C37, wherein using the first and second routing distances to select one or more of the first and second candidate target peers comprises determining that one or more of the first and second candidate target peers meets distance criteria.

C39. The method of any one of embodiments C34A-C38, wherein using the first and second routing distances to select one or more of the first and second candidate target peers comprises selecting a data network access identifier (DNAI) and a local packet data unit (PDU) session anchor (PSA) at a location identified by the DNAI.

C40. The method of embodiment C39, wherein using the first and second routing distances to select one or more of the first and second candidate target peers comprises determining that the selected local PSA and the selected one or more of the first and second candidate target peers correspond to the selected DNAI.

C41. The method of any one of embodiments C1-C40, further comprising: using the first and second routing distances to decide to change a local packet data unit (PDU) session anchor (PSA) to a new local PSA; selecting the new local PSA; and initiating a change of local PSA to the selected new local PSA.

C42. The method of any one of embodiments C1-C41, further comprising conveying the selected one or more of the first and second candidate target peers to a local domain name system resolver (LDNSR).

C43A. The method of any one of embodiments C1-C42, wherein peer selection unit is a session management function (SMF).

C43B. The method of embodiment C43A, further comprising deferring selection of a new local packet data unit (PDU) session anchor (PSA) if none of the first and second candidate target peers meets distance criteria.

C44. The method of any one of embodiments C1-C24, wherein the peer selection unit is a network function (NF) service consumer, the first and second candidate target peers are network functions (NFs), the first and second routing distances are between the NFs and the location of the source peer, and using the first and second routing distances to select one or more of the first and second candidate target peers comprises selecting a candidate target NF that is topologically close to the NF service consumer.

C45. The method of embodiment C44, wherein the source peer is the NF service consumer.

C46. The method of embodiment C45, wherein the target peer discovery query includes location information for the NF service consumer.

C47. The method of any one of embodiments C44-C46, wherein the NFs are part of a 5G Core (5GC) control plane defined as part of a service-based architecture (SBA).

D1. A peer selection unit (404) adapted to: convey a target peer discovery query related to the selection of a target peer for a source peer (402); receive a response identifying first and second candidate target peers, wherein the response includes distance information, and the distance information includes a first routing distance between a location of the first candidate target peer and the location of the source peer and a second routing distance between a location of the second candidate target peer and the location of the source peer; and use the first and second routing distances to select one or more of the first and second candidate target peers.

E1. A method performed by a local domain name server resolver (LDNSR) (706, 806), the method comprising: conveying a domain name server (DNS) query including a fully qualified domain name (FQDN) requested by a user equipment (UE) (702, 802), wherein the DNS query includes location information indicating a location of the UE; receiving a DNS response identifying first and second candidate edge application servers (EASs), wherein the DNS response includes distance information, and the distance information includes a first routing distance between a location of the first candidate EAS and the location of the UE and a second routing distance between a location of the second candidate EAS and the location of the UE; and conveying identifications of the first and second candidate EASs and the distance information to a session management function (SMF) (704, 804) for the UE.

E2. The method of embodiment E1, wherein the location information indicating the location of the UE includes an Internet Protocol (IP) address or address range.

E3. The method of embodiment E2, wherein the IP address of the location information corresponds to a data network access identifier (DNAI) and/or a local packet data unit (PDU) session anchor (PSA) selected by a session management function (SMF) for the location of the UE.

E4. The method of any one of embodiments E1-E3, wherein the FQDN of the DNS query includes the location information.

E5. The method of any one of embodiments E1-E3, wherein a DNS extension (EDNS) to the DNS request includes the location information.

E6. The method of embodiment E5, wherein the EDNS is an EDNS client subnet (ECS) extension.

E7. The method of any one of embodiments E1-E3, wherein a zero (Z) header of the DNS query includes the location information.

E8. The method of any one of embodiments E1-E7, wherein the DNS response includes the distance information.

E9. The method of any one of embodiments E1-E8, wherein an extension to the DNS response includes the distance information.

E10. The method of any one of embodiments E1-E8, wherein a zero (Z) header of the response includes the distance information.

E11. The method of any of embodiments E1-E10, wherein the identifications of the first and second candidate EASs include the first and second routing distances, respectively.

E12. The method of embodiment E10 or E11, wherein the identifications of the first and second candidate EASs include FQDNs of the first and second candidate EASs, respectively.

E13. The method of embodiment E12, wherein the FQDNs of the first and second candidate EASs include the first and second routing distances, respectively.

E14. The method of any one of embodiments E1-E13, further comprising: receiving a DNS query from the UE, wherein the received DNS query includes the FQDN requested by UE; and modifying the received DNS query to create the conveyed DNS query.

E15. The method of embodiment E14, wherein modifying the received DNS query comprising adding the location information indicating the location of the UE.

E16. The method of any one of embodiments E1-E15, further comprising: receiving a list of one or more selected EASs conveyed by the SMF; and conveying a DNS response including identifications of the one or more selected EASs.

E17. The method of embodiment E16, wherein the list of one or more selected EASs includes FQDNs of the one or more selected EASs.

E18. The method of embodiment E16 or E17, wherein the identifications of the one or more selected EASs include Internet Protocol (IP) addresses and/or FQDNs of the one or more selected EASs.

E19. The method of any one of embodiments E1-E18, further comprising buffering the conveyed DNS query for early DNS handling and conveying the buffered DNS query with a different DNS extension (EDNS) client subnet (ECS) option.

E20. The method of any one of embodiments E1-E19, further comprising conveying the FQDN requested by the UE to the SMF.

E21. The method of any one of embodiments E1-E19, further comprising: receiving an identification of a candidate local packet data unit (PDU) session anchor (PSA); conveying a second DNS query, wherein the second DNS query includes location information corresponding to the location of the candidate local PDU; receiving a second DNS response identifying candidate EASs, wherein the DNS response includes second distance information, and the second distance information includes routing distances between locations of the candidate EASs and the location of the candidate local PSA; and conveying identifications of the candidate EASs and the second distance information to the SMF.

F1. A local domain name server resolver (LDNSR) (706, 806) adapted to: convey a domain name server (DNS) query including a fully qualified domain name (FQDN) requested by a user equipment (UE) (702, 802), wherein the DNS query includes location information indicating a location of the UE; receive a DNS response identifying first and second candidate edge application servers (EASs), wherein the DNS response includes distance information, and the distance information includes a first routing distance between a location of the first candidate EAS and the location of the UE and a second routing distance between a location of the second candidate EAS and the location of the UE; and convey identifications of the first and second candidate EASs and the distance information to a session management function (SMF) (704, 804) for the UE.

G1. A computer program comprising instructions for adapting an apparatus to perform the method of any one of embodiments A1-A38, C1-C47, and E1-E21.

H1. A carrier containing the computer program of embodiment G1, wherein the carrier is one of an electronic signal, optical signal, radio signal, or compute readable storage medium.

Il. An apparatus (1101), the apparatus comprising: processing circuitry (1102); and a memory (1142), said memory containing instructions (1144) executable by said processing circuitry, whereby said apparatus is operative to perform the method of any one of the embodiments A1-A38, C1-C47, and E1-E21.

J1. An apparatus (1101) adapted to perform the method of any one of embodiments A1-A38, C1-C47, and E1-E21.

K1. Any combination of the embodiments set forth above.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a peer discovery unit, the method comprising:
receiving a target peer discovery query related to the selection of a target peer for a source peer;
obtaining location information indicating a location of the source peer;
selecting first and second candidate target peers;
using the location information for the source peer to determine distance information, wherein the distance information includes a first routing distance between a location of the first candidate target peer and the location of the source peer and a second routing distance between a location of the second candidate target peer and the location of the source peer; and
conveying a response identifying the first and second candidate target peers, wherein the response includes the distance information.

2. The method of claim 1, wherein the target peer discovery query includes the location information for the source peer.

3. The method of claim 1, wherein the target peer discovery query includes an identification of a target peer, wherein the identification of the target peer preferably includes the location information for the source peer, and/or the identification of the target peer preferably includes a fully qualified domain name (FQDN) of the target peer.

4. The method of claim 1, wherein the target peer discovery query is a domain name system (DNS) query.

5. The method of claim 4, wherein a zero (Z) header of the DNS query includes the location information for the source peer.

6. The method of claim 1, wherein an attribute of the target peer discovery query includes the location information.

7. The method of claim 1, wherein an extension to the response includes the distance information.

8. The method of claim 1, wherein a zero (Z) header of the response includes the distance information.

9. The method of claim 1, wherein the response includes identifications of the first and second candidate target peers.

10. The method of claim 9, wherein the identifications of the first and second candidate target peers include the first and second routing distances, respectively.

11. The method of claim 9, wherein the identifications of the first and second candidate target peers include fully qualified domain names (FQDNs) of the first and second candidate target peers, respectively, and the FQDNs of the first and second candidate target peers preferably include the first and second routing distances, respectively.

12. The method of claim 1, wherein the first and second routing distances are site location coordinates.

13. The method of claim 1, wherein the first and second candidate target peers are edge application servers (EASs).

14. The method of claim 13, wherein the source peer is a local packet data unit (PDU) session anchor (PSA).

15. The method of claim 13, wherein the target peer discovery query was conveyed by a mobile network operator (MNO) domain name system (DNS), the location information is an Internet Protocol (IP) address of the source peer, the response includes IP addresses that identify the EASs, and the first and second routing distances are between the EASs and the location of the source peer.

16. The method of claim 32, wherein the target peer discovery query was conveyed by a local domain name system resolver (LDNSR), the response includes IP addresses that identify the EASs, and the first and second routing distances are between the EASs and the location of the source peer.

17. (canceled)

18. A method performed by a peer selection unit, the method comprising:
conveying a target peer discovery query related to the selection of a target peer for a source peer;
receiving a response identifying first and second candidate target peers, wherein the response includes distance information, and the distance information includes a first routing distance between a location of the first candidate target peer and a location of the source peer and a second routing distance between a location of the second candidate target peer and the location of the source peer; and
using the first and second routing distances to select one or more of the first and second candidate target peers.

19. The method of claim 18, wherein the target peer discovery query includes location information for the source peer.

20. The method of claim 18, wherein the target peer discovery query includes an identification of a target peer, the identification of the target peer preferably includes the location information for the source peer, and the identification of the target peer preferably includes a fully qualified domain name (FQDN) of the target peer.

21. The method of claim 18, wherein the target peer discovery query is a domain name system (DNS) query.

22-40. (canceled)
